(19) United States
(12) Patent Application Publication
(10) Pub. No.: US 2025/0094190 A1
(43) Pub. Date: Mar. 20, 2025

(54) Automated Operation Tracking, Verification, and Interface Updating System

(71) Applicant: Staples, Inc., Framingham, MA (US)

(72) Inventors: Gregory Patrick Cox, Sleepy Hollow, NY (US); Matthew Douglas, Orlando, FL (US); Brandon Lam, Rockland, MA (US); Jerrica VanAlystne, Graham, NC (US); Edilio Vera, Austin, TX (US); Ivan Huerta, Middletown, NY (US); Travis Shives, Warfordsburg, PA (US)

(21) Appl. No.: 18/886,875

(22) Filed: Sep. 16, 2024

Related U.S. Application Data
(60) Provisional application No. 63/583,106, filed on Sep. 15, 2023.

(51) Int. Cl. G06F 9/451; G06F 3/0482; G06Q 10/087

(52) U.S. Cl. CPC G06F 9/453; G06F 3/0482; G06Q 10/087

(57) ABSTRACT

A system may provide, by a graphical user interface, a first instruction to a user to perform a first scan of one or more first items at a first location. The system may receive the first scan of the one or more first items and identify, based on the first scan, the one or more first items. The system may update the graphical user interface based on the identified one or more first items and may update a computer file associated with the first instruction to indicate a scan of the one or more first items. Various process or workflows may be determined and proceeded through using scans on a client picking device in an efficient and rapid manner.

### BACKGROUND

This application relates to inventory management systems (e.g., order distribution or fulfillment systems). For example, this application relates to an automated system for picker communication, asset tracking, and pick automation.

Some current inventory management and fulfillment systems use robotic devices while others use human pickers. The human pickers may receive their tasks on paper pack slips that instruct the user to pick defined items into shipping containers. In other systems, the human pickers may be instructed by lights or voice prompts indicating which operations the pickers should perform to pack objects.

Unfortunately, current systems either do not allow dynamic modification of user interfaces and tasks, use complicated interfaces that result in slow picker performance or errors, or do not provide interaction with automated mechanisms in the warehouse, which is very limiting. For example, a current system may require that a user navigate through menus and tasks, resulting in numerous modes via which delay can occur or errors input into the system.

Pickers may also be assigned various tasks in an inventory management and fulfillment system, for example, they may move within a warehouse to find items, interact with robots, pack and unpack trucks, and perform various types of tasks. However, these dynamic environments further exacerbate the shortcomings of current systems.

These deficiencies lead to significant inefficiencies in resource utilization, imbalanced equipment workloads, and other problems, such as inaccurate picks and delays. Accordingly, the present technology addresses these and other shortcomings.

### SUMMARY

A picking system can be configured to perform particular operations or actions by virtue of having software, firmware, hardware, or a combination of them installed on the system that in operation causes or cause the system to perform the actions. Similarly, various hardware components are described that improve picking technologies, including over those issues described in the Background.

In some aspects, the techniques described herein relate to a computer-implemented method including: providing, by one or more processors via one or more graphical user interfaces, a first instruction to a user to perform a first scan of one or more first items at a first location; receiving, by the one or more processors, the first scan of the one or more first items; identifying, by the one or more processors, the one or more first items based on the first scan; updating, by the one or more processors, the one or more graphical user interfaces, based on the identified one or more first items; and updating, by the one or more processors, a computer file associated with the first instruction to indicate a scan of the one or more first items.

In some aspects, the techniques described herein relate to a computer-implemented method, further including: receiving, by the one or more processors, scan data of a second scan of a first label at a work location, the second scan preceding the first scan; and based on the second scan, determining a process flow including a set of multiple graphical user interfaces indicating a set of multiple tasks for the work location, the set of multiple graphical user interfaces including the one or more graphical user interfaces.

In some aspects, the techniques described herein relate to a computer-implemented method, further including: receiving, by the one or more processors, a second scan of a first carton; identifying, by the one or more processors, the first carton based on the second scan; and associating, by the one or more processors, the one or more first items with the first carton based on the second scan of the first carton in the computer file.

In some aspects, the techniques described herein relate to a computer-implemented method, further including: displaying, by the one or more processors, a graphical user interface requesting verification of a quantity of the one or more first items based on receiving the first scan; and based on receiving the verification of the quantity, displaying a subsequent task in a task list on the one or more graphical user interfaces, the task list including a pick of the one or more first items and the subsequent task including a pick of one or more second items.

In some aspects, the techniques described herein relate to a computer-implemented method, further including: providing, by the one or more processors via the one or more graphical user interfaces, a second instruction to the user to apply one or more labels to a first carton based on the first scan and the identified one or more first items.

In some aspects, the techniques described herein relate to a computer-implemented method, further including: determining, by the one or more processors, one or more purchase orders, the one or more purchase orders identifying a set of items expected to be received in one or more shipments; receiving, by the one or more processors, second scan data for a second scan of one or more of a pallet label and a case label in the one or more shipments; and determining, by the one or more processors, the first instruction indicating the one or more first items based on the second scan.

In some aspects, the techniques described herein relate to a computer-implemented method, further including: determining, by the one or more processors, expiration information for the one or more first items using a client picking device; and displaying, by the one or more processors on the one or more graphical user interfaces, handling information based on the determined expiration information.

In some aspects, the techniques described herein relate to a computer-implemented method, wherein: the one or more graphical user interfaces providing the first instruction are displayed on portable client picking device, the portable client picking device being wirelessly communicatively coupled with a scanning device to receive scan data from the first scan.

In some aspects, the techniques described herein relate to a computer-implemented method, wherein: the first instruction is displayed on a graphical user interface including a single active instruction, the one or more processors determining an operation based on the first instruction being displayed and the first scan being received.

In some aspects, the techniques described herein relate to a computer-implemented method, wherein: the user navigates through a workflow of graphical user interfaces by scanning external labels on one or more of a pallet, a physical location, a carton, and a product.

In some aspects, the techniques described herein relate to a system including: one or more processors; and a computer-memory storing instructions that, when executed by the one or more processors, cause the one or more processors to perform operations including: providing, via one or more graphical user interfaces, a first instruction to a user to perform a first scan of one or more first items at a first location; receiving the first scan of the one or more first items; identifying the one or more first items based on the first scan; updating the one or more graphical user interfaces, based on the identified one or more first items; and updating a computer file associated with the first instruction to indicate a scan of the one or more first items.

In some aspects, the techniques described herein relate to a system, wherein the operations further include: receiving scan data of a second scan of a first label at a work location, the second scan preceding the first scan; and based on the second scan, determining a process flow including a set of multiple graphical user interfaces indicating a set of multiple tasks for the work location, the set of multiple graphical user interfaces including the one or more graphical user interfaces.

In some aspects, the techniques described herein relate to a system, wherein the operations further include: receiving a second scan of a first carton; identifying the first carton based on the second scan; and associating the one or more first items with the first carton based on the second scan of the first carton in the computer file.

In some aspects, the techniques described herein relate to a system, wherein the operations further include: displaying a graphical user interface requesting verification of a quantity of the one or more first items based on receiving the first scan; and based on receiving the verification of the quantity, displaying a subsequent task in a task list on the one or more graphical user interfaces, the task list including a pick of the one or more first items and the subsequent task including a pick of one or more second items.

In some aspects, the techniques described herein relate to a system, wherein the operations further include: providing, via the one or more graphical user interfaces, a second instruction to the user to apply one or more labels to a first carton based on the first scan and the identified one or more first items.

In some aspects, the techniques described herein relate to a system, wherein the operations further include: determining one or more purchase orders, the one or more purchase orders identifying a set of items expected to be received in one or more shipments; receiving second scan data for a second scan of one or more of a pallet label and a case label in the one or more shipments; and determining the first instruction indicating the one or more first items based on the second scan.

In some aspects, the techniques described herein relate to a system, wherein the operations further include: determining expiration information for the one or more first items using a client picking device; and displaying, on the one or more graphical user interfaces, handling information based on the determined expiration information.

In some aspects, the techniques described herein relate to a system, wherein the operations further include: the one or more graphical user interfaces providing the first instruction are displayed on portable client picking device, the portable client picking device being wirelessly communicatively coupled with a scanning device to receive scan data from the first scan.

In some aspects, the techniques described herein relate to a system, wherein the operations further include: the first instruction is displayed on a graphical user interface including a single active instruction, the one or more processors determining an operation based on the first instruction being displayed and the first scan being received.

In some aspects, the techniques described herein relate to a system, wherein the operations further include: the user navigates through a workflow of graphical user interfaces by scanning external labels on one or more of a pallet, a physical location, a carton, and a product.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system and data communication flow for an automated operation tracking, verification, and interface updating system.

FIG. 2 is a flowchart of an example method for picking items to cartons.

FIG. 3 is a flowchart of an example method for receiving items in shipments.

FIGS. 4A-4F illustrate an example workflow or series of graphical user interfaces for a bulk picking method.

FIGS. 5A-5C illustrate an example workflow for an example cart building method.

FIGS. 6A-6L illustrate an example workflow for a method of picking to a cart.

FIGS. 7A-7C illustrate an example workflow of an example method for finalizing a cart.

FIGS. 8A-8D illustrate an example workflow of a method of finalizing a batch cart.

FIGS. 9A-9E illustrate an example workflow of a method for receiving new items into a warehouse.

FIGS. 10A-10E illustrate an example workflow for an example method of picking item units.

FIG. 11 is a block diagram illustrating an example computing device.

### DESCRIPTION

Among other benefits, the technology described herein improves upon that described in the Background Section. For instance, the technology provides various interfaces, systems, and methods that allow a human user to quickly, accurately, and dynamically interact with a warehouse and fulfillment system. For example, the system may include a server (e.g., referred to herein as a picking server or system) that interacts with a warehouse execution or management system to determine information for cartons, carts, orders, purchase orders, picking tasks, or other data. For instance, the server may communicate with one or more other systems to determine picking tasks, coordinate with automated guided vehicles or other robots, confirm completion of various tasks or otherwise.

In some implementations, the technology may include portable/mobile client computing devices (also referred to herein as picking devices 158), which may be carried by a human picker and used to interact with the picking server/system to receive outputs therefrom and provide inputs thereto. For example, the technology may provide various inputs and outputs including graphical user interfaces, sensors, and other input or output devices. The picking devices 158 may be small handheld or wrist-mounted devices, such as smart phones, smart watches, or other devices, such as an approximately 3-inch Android™ device (e.g., a Unitech™ WD200). For instance, a small, wrist mounted display may be coupled with a clove to which an optical scanner is attached and into which a scan trigger is integrated (e.g., a Proglove™ Mark scanner glove). The technologies described herein allow, and even benefit from, very small screen devices on the order of 1 to 4-inch (e.g., the 3.1-inch Unitech™ WD200) displays, although they may be used with other devices.

For instance, the technologies described herein are specifically designed to maximize interaction efficiency, minimize distractions and potential input errors, and improve performance of small-screen devices, as described below.

In some implementations, the picking devices 158 may include, be wiredly coupled with, or wirelessly coupled with one or more sensors. The sensor(s) may include an optical sensor for scanning QR codes, bar codes, or identifying visual information (numbers, visual attributes, etc.), or they may include an RFID reader, NFC reader, or various other devices. A picking device 158 may automatically receive a scan from the sensor(s) and use the scan data to update a graphical user interface, track tasks, and communicate with a picking system 108/server, as described elsewhere herein. Similarly, the picking device 158 may automatically, based on scans, task lists, and data from a picking system 108, provide graphical interfaces and elements in a simplified interface that allows the small display size to be efficiently used and reduce delay due to user interaction and errors. For example, the picking device 158 may transmit scan data to a warehouse management system 104, which determines a carton, item, or task based on the scan data and transmits instructions to the picking device 158. The warehouse management system may use these communications to coordinate the actions of multiple human agents, robots, automated guided vehicles 114, delivery vehicles, and other equipment or assets, thereby increasing overall efficiency, accuracy, and safety.

The technology may use these interactions to select an optimal set of tasks for the picker and/or other resources to reduce downtime of the resource, increase efficiency and utilization of equipment, reduce computation loads, and speed up preparation of cartons and otherwise.

The technology may also manage the priority of individual tasks based on various carton, item, or other data in the distribution facility. For instance, the technology may track inventory levels, orders, expiration dates/information, and other information to efficiently receive inputs and provide tasks to pickers.

Features of the technology described herein can be integrated into any logistics system, dispatch system 106, warehouse execution system 102, warehouse management system 104, a robot execution server 132, picking system 108, etc., to coordinate task among a plurality of resources. This technology beneficially improves productivity and throughput, increases asset utilization, and lowers cycle time and labor costs. These benefits, in turn, lead to shorter delivery times and result in significant value.

The technology described herein provides numerous benefits. For example, because picking numerous products at numerous locations in a warehouse is inherently a complicated process, previous devices displayed very complicated interfaces with menus, drop down lists, and many other complications. These issues result in slow processing on small screen devices and confusion by human pickers using the interfaces.

The technology described herein provides very simple graphical user interfaces in which individual steps are individually broken out into interfaces where single instructions, single inputs, or very limited instructions/inputs are available. Additionally, in some implementations, because individual steps are simply broken out into very minimalistic interfaces, the technology may omit unnecessary steps and options by performing intelligent backend processing. Additionally, in some implementations, because only one or limited inputs may be used in some interfaces, the technology may receive a scan for a given interface without requiring any additional input on the interface, so that the process flows through interfaces may proceed based solely on scans, for example, without interacting with the graphical interfaces (e.g., on a touchscreen picking device 158). Accordingly, complex processes may be simplified into simple interfaces for small screen devices with quick inputs (e.g., via a connected scanner).

Additionally, although not specifically shown in the figures herein, in some implementations, the picking system 108 or WMS 104 may track tasks and devices in real time. The picking system 108 may perform and display analytics associated with the picking tasks, progress through graphical interfaces, or other data points to stakeholders or administrators, for example, on a webpage.

With reference to the figures, reference numbers may be used to refer to components found in any of the figures regardless of whether those reference numbers are shown in the figure being described. Further, where a reference number includes a letter (e.g., suffix) referring to one of multiple similar components (e.g., component 000a, 000b, and 000n), the reference number may be used without the letter to refer to one or all of the similar components.

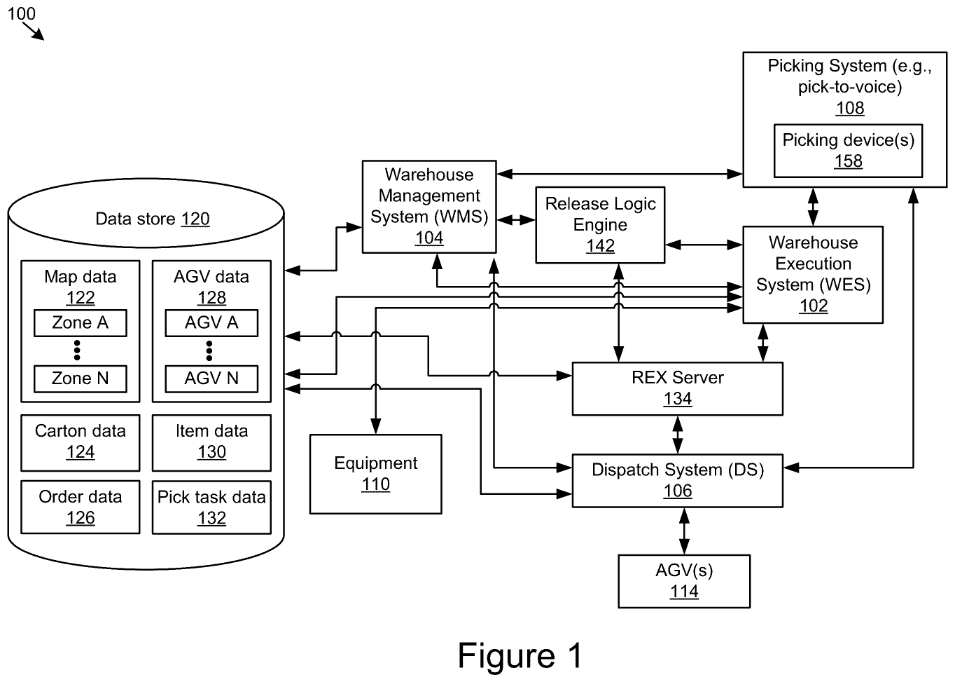

FIG. 1 is a block diagram of an example system 100 and data communication flow for an automated operation tracking, verification, and interface updating system. The system 100 includes a warehouse execution system (WES) 102. The WES 102 is coupled to equipment 110 (e.g., conveyor controls, conveyor scanners, conveyors, automated induction equipment, other warehouse equipment, etc.), a warehouse management system (WMS) 104, a data store 120 storing warehouse management, execution, dispatch, picking, carton, order, item, AGV, map, and/or other data, a picking system 108 (e.g., pick-to-voice, pick-to-light, etc.), a robot execution server (REX) 134, and a dispatch system 106, although additional or fewer devices are possible and contemplated herein.

The WES 102 may, in some implementations, include one or more hardware and/or virtual servers programmed to perform the operations, acts, and/or functionality described herein. The components of the WES 102 may comprise software routines storable in one or more non-transitory memory devices and executable by one or more computer processors of the WES 102 to carry out the operations, acts, and/or functionality described herein. In further implementations, these routines, or a portion thereof, may be embodied in electrical hardware that is operable to carry out the operations, acts, and/or functionality described herein.

The REX 134 may, in some implementations, include one or more hardware and/or virtual servers programmed to perform the operations, acts, and/or functionality described herein. The REX 134 may generate a schedule that defines the route for an AGV during a picking session, as described herein. For a given AGV 114, depending on the items (e.g., identified by stock keeping units or SKUs) to be placed in the cartons of a cart coupled thereto, the REX 134 generates a schedule and transmits it to the dispatch system 106, which in turn deploys an AGV 114 and/or cart according to the schedule, for instance. In some implementations, the dispatch system 106 instructs the AGV to proceed through one or more of the picking zones of the distribution facility according to the schedule. The schedule of the AGVs may be coordinated such that an optimal flow can be achieved, as discussed elsewhere herein.

In some implementations, the REX 134 may include or may communicate with a SKU (e.g., a stock keeping unit or unique identifier identifying an item) routing engine. The SKU routing engine is executable to route items into different storage zones/areas based on picking profiles of the items, which may be stored and maintained as item data 130. The SKU routing engine dynamically monitors the picking activity in the distribution facility (e.g., in communication with a picking system 108), tracks which items have the highest volume or velocity for a given timeframe, stores the tracking data in the data store 120, and can instruct the REX 134 to have items relocated by AGVs to different storage locations in the distribution facility based on the tracked picking activity. For example, the SKU routing engine, REX server 134, and picking system 108 may coordinate tasks, as described elsewhere herein. In some implementations, the REX 134 may use the batches or lists generated by the release logic engine 142 (described below) when generating the schedule for the AGVs, for example, for an AGV 114.

A picking profile of a given item can change over time as demand for the item changes. The demand for a given item may be random or predictable (e.g., seasonal), and may change based on time of day, week, month, year, etc. The item routing engine may maintain the picking profile in the database as item data 130 and utilize that data to determine in which zone of the distribution facility to store the item.

The WES 102 may store productivity information for points in the distribution facility in a database (e.g., a non-transitory data store 120). The productivity information may reflect the capacity of that given point of the system. In some cases, a mechanical capacity may be dynamic based on current conditions (e.g., system health, staffing levels (e.g., number of associates working in zone), stock levels, operational state, etc.). For instance, the WES 102, WMS 104, picking system 108, or another component may be used to assign tasks to resources based on input from a picking device 158, as described elsewhere herein.

The dispatch system 106 may be electronically communicatively coupled to a plurality of AGVs 114. In some implementations, the dispatch system 106, or elements thereof, may be integrated with or communicatively coupled with the REX 134. The dispatch system 106 includes hardware and software configured to dispatch the AGVs 114 and is coupled for communication the components of the system 100 to receive instructions and provide data. The dispatch system 106 may calculate a route to execute the task considering traffic and resources. In some cases, it uses the location, task, and status information provided by picking device(s) 158 to dispatch AGVs 114 or set their routes.

The AGVs 114 are robotic vehicles including drive units providing motive force for moving the AGVs 114 (and, in some instances, carts, modular storage units, pallets, mini-pallets, AGV racks, AGV shelves, etc.), guidance systems for determining the positions of the AGVs within the distribution facility, and equipment for carrying items. The equipment for carrying items may include carton holders, AGV shelves, modular storage unit holders, etc., such as carts, shelves, etc., for example.

A modular storage unit (also referred to simply as a storage unit) may be a container in which items are stored, for example, in high-density storage (e.g., on closely placed, tall, or otherwise dense shelving). In some instances, the modular storage unit may be transported by an AGV 114. For example, a modular storage unit may comprise a pallet or tote, which may be a holding vessel to support items designed to be picked up by an AGV 114. For example, a modular storage unit may include a pallet and a holding structure that supports items designed to be picked up by an AGV with forks or another carrying surface. In some implementations, a pallet may be stackable. In some implementations, a pallet may be attachable to a container to form a modular storage unit.

An AGV 114 may include an automated guided vehicle or robot configured to autonomously transport carton from a preparation or induction area to a pick-to-cart area of the distribution facility, a goods-to-person station, and/or finalizing area. The AGV 114 may include a drive unit adapted to provide motive force to the AGV 114 and a guidance system adapted to locate the cart in the distribution facility. In some implementations, the AGV 114 is adapted to autonomously transport a carton holder (e.g., a cart or shelves) that is, in turn, adapted to hold cartons. Cartons may include, for instance, a box (e.g., a shipping box) adapted to hold items. For example, an AGV 114 may push/pull a cart holding cartons around a pick-to-cart area and/or goods-to-person area and may automatically stop at storage bays of the pick-to-cart area where items to be picked are stored, so that a picker in the pick-to-cart area can easily place items into one or more of the cartons. In some instances, an AGV 114 may transport the cart to a pick-cell station to receive additional items into the cartons from high-density storage (e.g., from modular storage units in high-density storage, as described below). In some instances, an AGV 114 may move a cart at walking speed next to, behind, or in front of a picker walking through the pick-to-cart area of the distribution facility. For example, a picker may be associated with a cart or AGV 114 by scanning the cart or AGV 114 with a picking device 158 and the picking system 108, WMS 104, or another system may coordinate movements and tasks between the picker and AGV 114, as described in further detail below.

In some implementations, an AGV 114 may include an automated guided vehicle or robot that may be configured to autonomously transport items from a high-density storage area of the distribution facility to a goods-to-person station (e.g., a pick-cell station or cartless station), replenishment area, and/or finalizing area, where a picker with a picking device 158 may scan or otherwise interact with the AGV 114 or object(s) carried by it. The AGV 114 may include a container handling mechanism that retrieves items or modular storage units from storage shelves (e.g., in the high-density storage area), places items on an item holder (e.g., an AGV shelf) coupled with the AGV 114, and replaces items on storage shelves or at a goods-to-person station. In some implementations, an AGV 114 may autonomously retrieve modular storage unit(s) containing items to be picked in an order from the high-density storage area. For instance, the AGV 114 may transport the modular storage unit(s) to a pick-cell station, so that a picker at the pick-cell station can pick items from the modular storage unit(s) and place them into cartons in a cart. For example, a cart AGV may transport a carton to a bay in the pick-to-cart area having a first item in an order, then to a pick-cell station where a separate AGV 114 has delivered or will deliver a second item (e.g., in a modular storage unit) in the order, so that a picker can place the second item into the carton with the first item, and so on and so forth. The process may be repeated as necessary, depending on the number of items to be placed in the carton(s), for example, at a pick-cell station. The system 100 may coordinate the timing, placement, and movement of the cartons, modular storage units, pick-cell station workload, and AGVs along with tasks sent to picking device(s) 158 and inputs or scans received from the picking device(s) 158.

The WMS 104 may, in some implementations, include one or more hardware and/or virtual servers or software routines storable in one or more non-transitory memory devices and executable by one or more processors to perform operations, acts, and/or functionality described herein. The WMS 104 may be configured to store and maintain carton data 124 in the data store 120. The carton data 124 includes information about cartons and/or containers in the system, such as a unique identifier for each carton or container, a carton or container type, the zones or areas a carton will visit, the number of pick lines a carton proceeds through or includes, and the priority for the carton. Some cartons may have a higher priority relative to other cartons and the system 100 may expedite handling of those cartons with higher priority relative to other cartons by the system 100. The carton data 124 may include a picklist defining the items the carton will contain. The WMS 104 may store data mapping items to the different pick zones (e.g., the pick-to-cart area, the high-density storage area, a particular modular storage unit, a particular location at a particular goods-to-person station, etc.). In some implementations, the WMS 104 may be configured to communicate the carton data 124 with the WES 102, the picking system 108, and/or dispatch system 106 in real time, in batches, as requested by these components, etc.

In some implementations, the system 100 may include a release logic 142 or other engine, although it should be noted that the features and operations of the release logic engine may be implemented on or distributed among other components of the system 100. For instance, the release logic engine 142 may receive data describing capacity and performance of system resources, such as workstations that print cartons, cart AGVs that transport carts, goods-to-person stations (e.g., pick-cell stations or cartless stations), picking system 108 client devices 158, pickers, conveyors, etc., and may direct operations of the resources.

The release logic engine 142 may receive a trigger to release a batch of cartons for a cart (e.g., a cart may hold 30 cartons) and may, based on priority, pick location, replenishment, cycle times, affinity, etc., select the batch of cartons for the cart. The release logic engine 142 may instruct a workstation to print the batch of cartons (either as a batch or one by one) and release them to receive picks on the cart. The release logic engine 142 may also release cartons to goods-to-person stations (either using carts or without using carts) to balance workload in the fulfillment center. It should be noted that although many of the operations are described herein in reference to a robotic system, the release logic engine 142 may also instruct human pickers and other distribution facility/center associates to prepare the cartons, transport carts, etc., as described herein, for example, by transmitting data to picking computing devices of the human associates instructing the computing devices (e.g., picking devices 158) to display instructions for carton preparation or other tasks, as noted elsewhere herein.

In some implementations, the release logic engine 142 may implement one or more scoring algorithms for selecting the cartons that are assigned to a certain cart or AGV 114, a certain goods-to-person station, picking device 158, or workflows for various areas of the fulfillment center, etc.

In some implementations, the system 100 (e.g., the WMS 104 or release logic engine 142) may manage priority (e.g., due to a target shipping time, expiration date of an item, etc.) of released and/or unreleased cartons, cartons that include picks of items that need to be replenished in a given area (e.g., in a bay, modular storage unit, etc.), and workload balancing among resources in the distribution facility. For instance, the system 100 may track a cut time by which a carton is assigned to be shipped and prepare the carton using the appropriate resources, such as by issuing instructions to a picking device 158 and/or AGV 114, and at the appropriate time to prepare it by the cut time. Additionally, or alternatively, the system 100 may determine workload, capacity, and performance of resources (e.g., carton preparation workstations, carts, various AGV types, goods-to-person stations, etc.) and use this data to balance workload, provide efficient operation, and manage priority cartons, as described in further detail below.

The picking system 108 may, in some implementations, include one or more hardware and/or virtual servers or software routines storable in one or more non-transitory memory devices and executable by one or more processors to perform the operations, acts, and/or functionality described herein. The picking system 108 may receive pick confirmations, for example, from pickers or operators (e.g., using barcode scanners, NFC, RFID chips, or other sensors or input methods, such as on picking devices 158) working within a pick zone (e.g., a pick-to-cart area, goods-to-person station, etc.) confirming that picks for a given carton have been performed, as described in further detail below. An example picking system 108 may include an available pick-to-voice or a pick-to-light system. The picking system 108 may be configured to communicate the pick confirmation data with the WES 102, WMS 104, or other components of the system in real time, in batches, as requested by the components of the system, etc.

The picking system 108 may receive input (e.g., pick confirmations) from pickers working within a pick zone. The picking system 108 transmits the input to the WES 102. The confirmatory input may include the time stamp reflecting completion of the picks in the zone, a unique identifier identifying the picker (operator), a unique identifier identifying the pick zone, a unique identifier identifying the AGV, and/or a unique identifier identifying the carton (e.g., a carton number).

In some implementations, each picker may have and be logged in to a picking device 158, which may be a portable device capable of displaying graphical user interfaces, communicating with the picking system 108, WES 102, WMS 104, etc., and receiving user inputs. A picking device 158 may include a smart watch, smartphone, tablet, or dedicated picking devices 158 (e.g., as noted above). A picking device 158, as noted above, may include, or be coupled with one or more sensors, such as an optical scanner for scanning QR or barcodes. The picking device 158 may include a small display that allows the graphical interfaces described herein to be displayed. In some implementations, the display may be a touch screen via which a picker may interact with the graphical user interface(s). For instance, the user may provide input to the picking device 158 via a button or touch screen. The user may also provide inputs to the device in response to certain prompts via a scanning device, as described in further detail below.

The data store 120 is an information source for storing and providing access to data. The data stored by the data store 120 may be organized and queried using various criteria including any type of data stored by it. The data store 120 may include data tables, databases, or other organized collections of data. An example of the types of data stored by the data store 120 may include, but is not limited to map data 122, AGV data 128, carton data 124, order data 126, modular storage unit data, item data 130, pick task data 132, etc. In some instances, the data store 120 may also include, conveying system attributes, picking data, picker attributes, sensor data, or other data types.

The data store 120 may be included in the WES 102, WMS 104, REX 134, or in another computing system and/or storage system distinct from but coupled to or accessible by the WES 102, WMS 104, REX 134, or other components of the system 100. The WES 102, picking system 108, REX 134, and/or dispatch system 106, for example, may store and maintain map data 122, order data 126, carton data 124, and AGV data 128. The data store 120 can include one or more non-transitory computer-readable mediums for storing the data. In some implementations, the data store 120 may store data associated with a database management system (DBMS) operable on a computing system. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The map data 122 may include data reflecting the 2 or 3-dimensional layout of the facility including the location of modular storage units, picking areas, lanes, equipment 110, storage shelving units, items, picking devices 158 (e.g., used by human agents), AGVs, etc. Map data 122 may indicate the attributes of the distribution facility, including attributes of resources (e.g., one or more pick-to-cart areas, high-density storage areas, induction areas, finalizing areas, goods-to-person stations, replenishment areas, etc.). For example, attributes of zones may include the number, quantity, and location of shelving units or bays, modular storage units, items, guidance system locators or markers, etc.

Carton data 124 may describe cartons in the system, which may be cartons (e.g., shipping containers) to which items are being picked as part of an order, cartons from which items are being picked, or other cartons. In some instances, the carton data may be updated based on input from the picking devices 158 or may be used to update the graphical user interfaces on the picking devices 158. In some implementations, other data, such as data about pallets, mini-pallets, storage containers, or otherwise may also be stored in the data store 120.

The order data 126 includes data about picking including orders, items picked, items to be picked, picking performance, picker identities, pick confirmations, locations items are picked from, etc. Order data 126 may indicate the quantity and identity of items in orders, shipping addresses, order priority, progress of order fulfillment, number of cartons in an order, etc. The order data may also include purchase orders defining the items expected or received in a shipment, for example.

Item data 130 may describe items available for picking in a distribution facility. The item data 130 may include unique identifiers for these items, the item volume (e.g., the total amount picked in a given window (e.g., in an hour, day, etc.)), the item velocity (e.g., number of different times an item picked in a given window (e.g., per hour, day etc.), the unique location of the items within the distribution facility (aisle, shelf, shelf position, etc.), barcode, UPC, or other identifying attributes, other attributes of the item (e.g., size, description, weight, quantity of items in a package, color, etc.), item inventory, mapping of items of modular storage units, etc. In some implementations, the item data 130 may include the quantity of particular items a modular storage unit contains, the current location of a mobile storage unit, a preferred storage location of items and/or modular storage units, a threshold inventory level of items to be satisfied before autonomously transporting the modular storage unit to a replenishment area by an AGV 114 (e.g., to restock the items in the modular storage unit).

Pick task data 132 may include pick tasks for pickers, AGVs 114, or other system resources. For instance, pick task data 132 may be generated for a certain order, picker, carton, process flow, or other detail for completing operations, such as picking an order, picking a carton, purchase order receiving, etc.

AGV data may describe the state of an AGV 114 (operational state, health, location, battery life, storage capacity, items being carried, cartons, etc.), whether picker is assigned to it, etc.

The components of the system 100 may be coupled to exchange data via wireless and/or wired data connections. The connections may be made via direct data connections and/or a computer network. The computer network may comprise any number of networks and/or types of networks, such as wide area networks, local area networks, virtual private networks, cellular networks, close or micro proximity networks (e.g., Bluetooth, NFC, etc.), etc. In some implementations, one or more of these components may be coupled via a data communications bus.

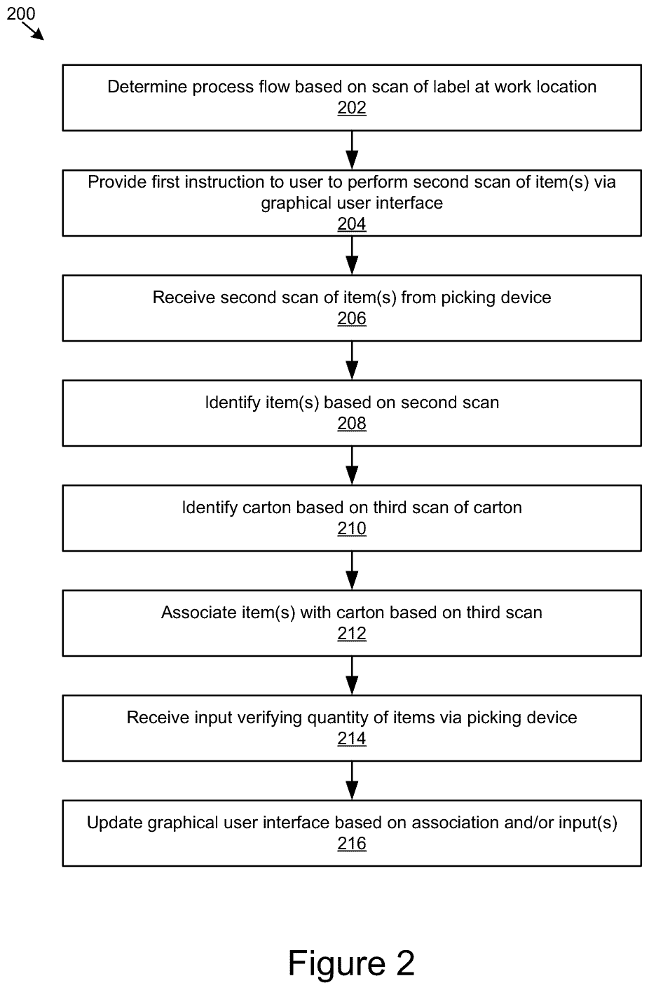

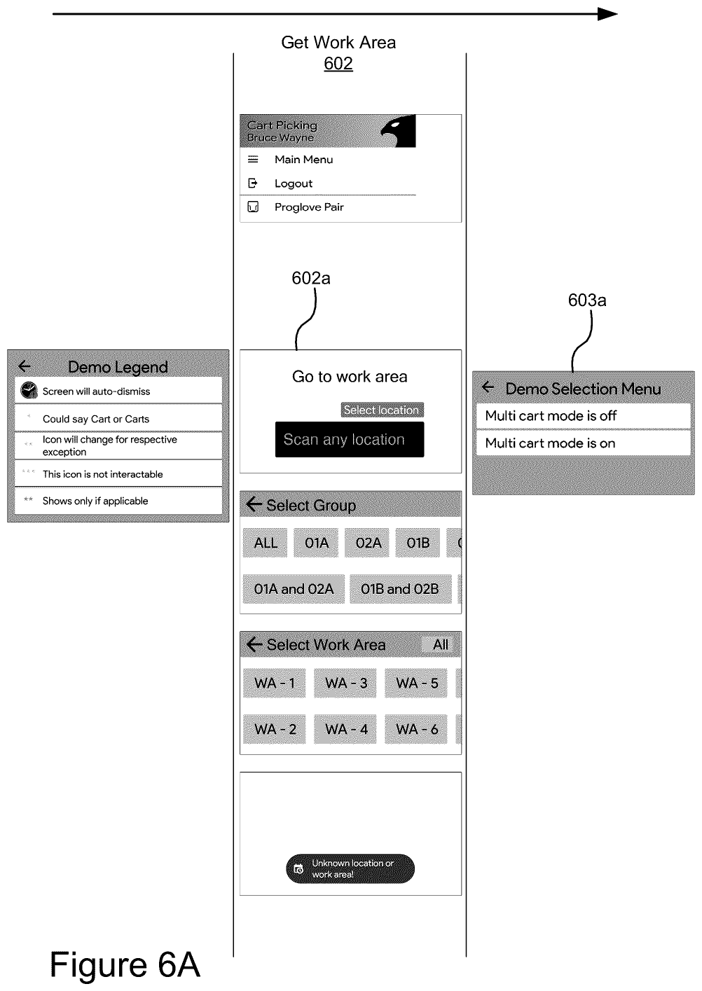

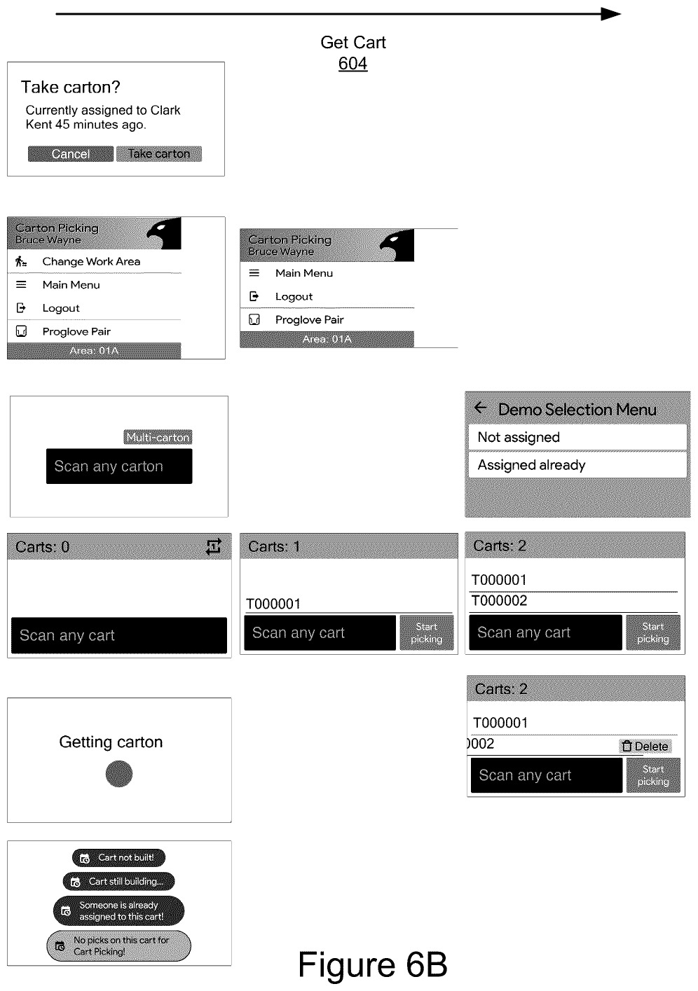

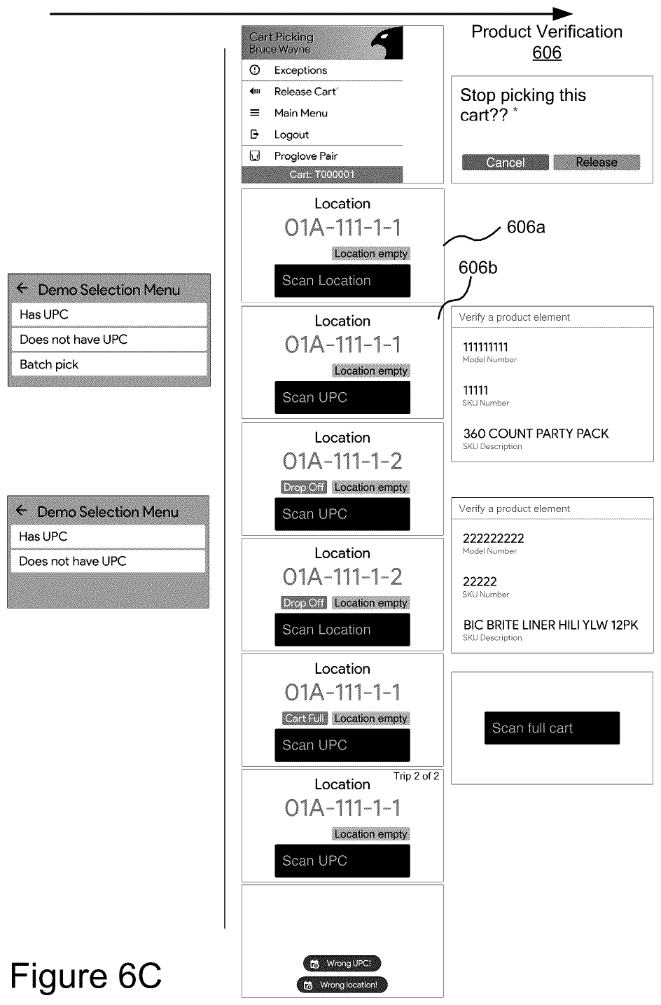

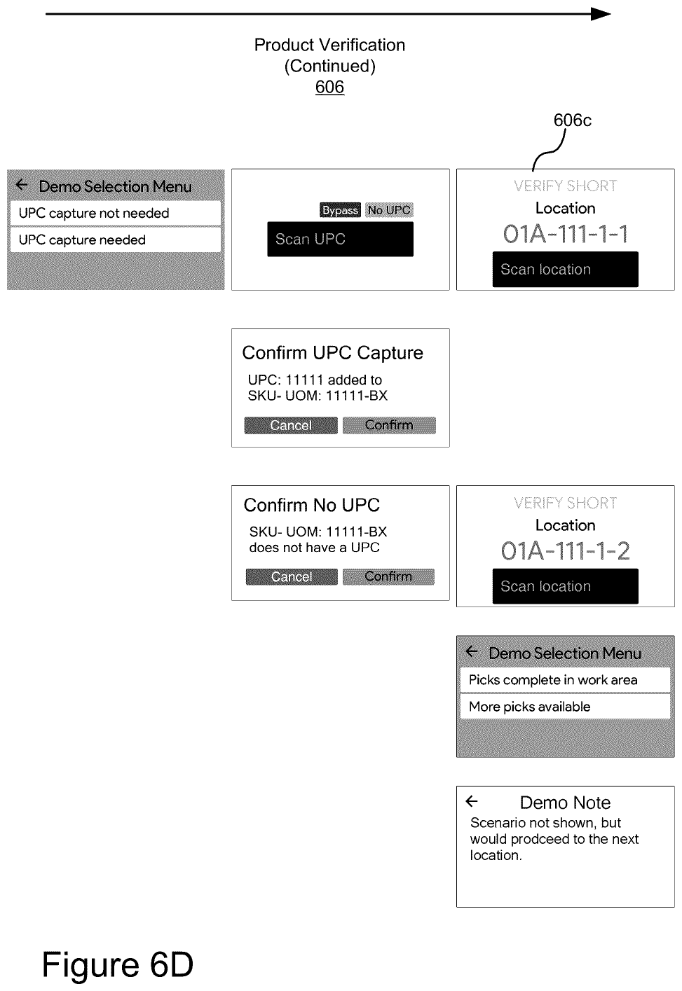

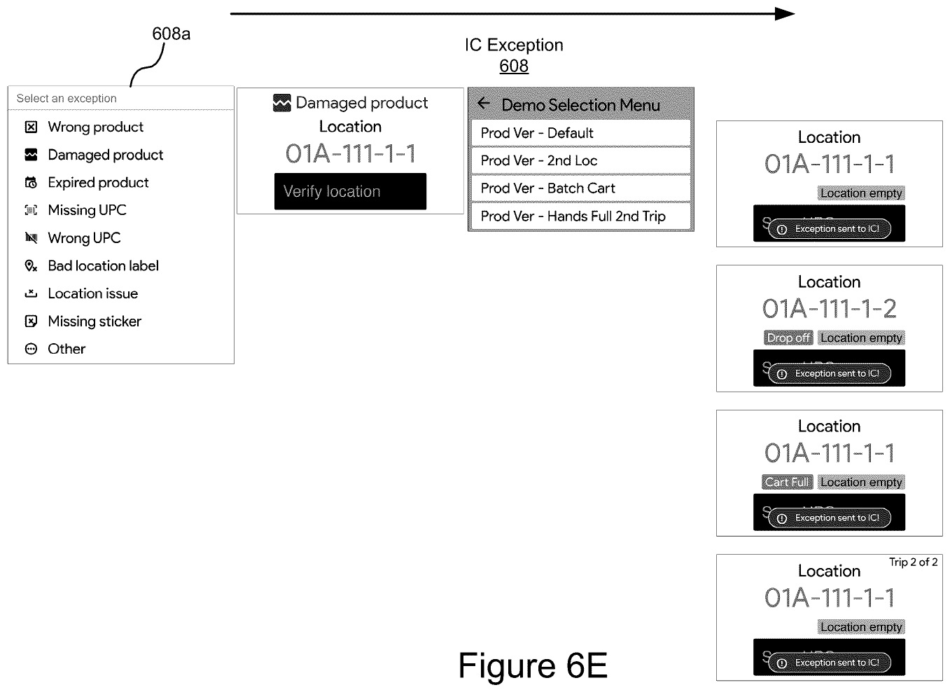

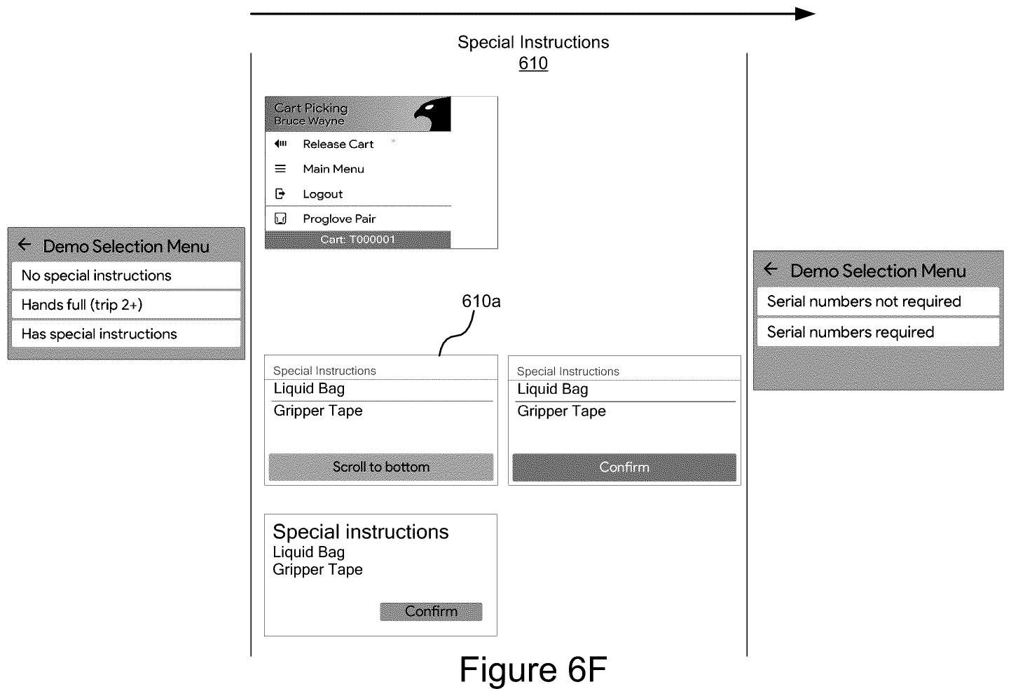

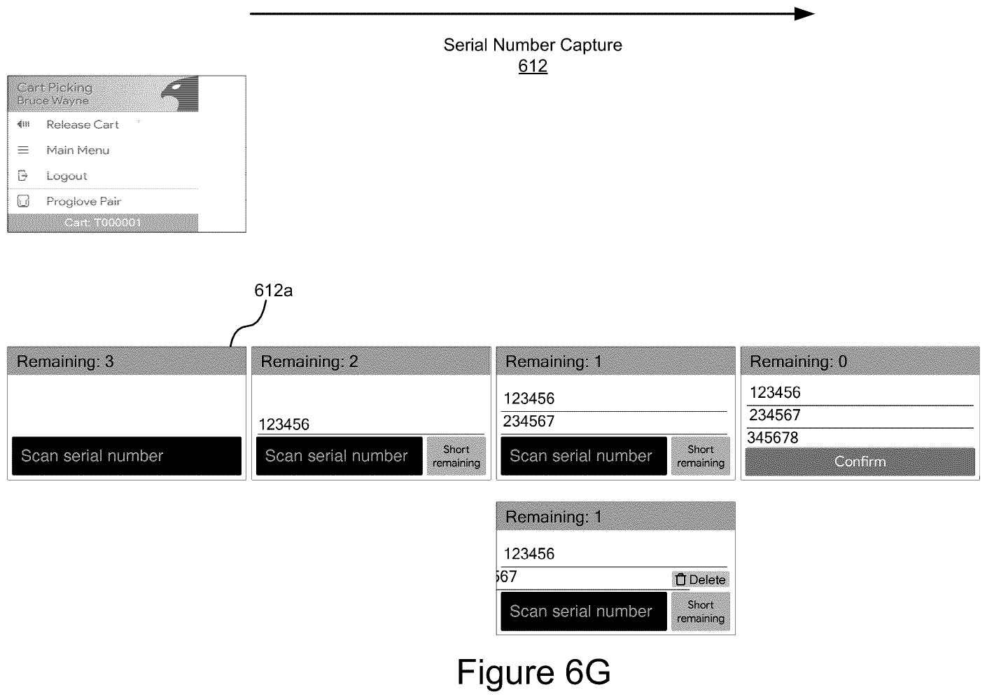

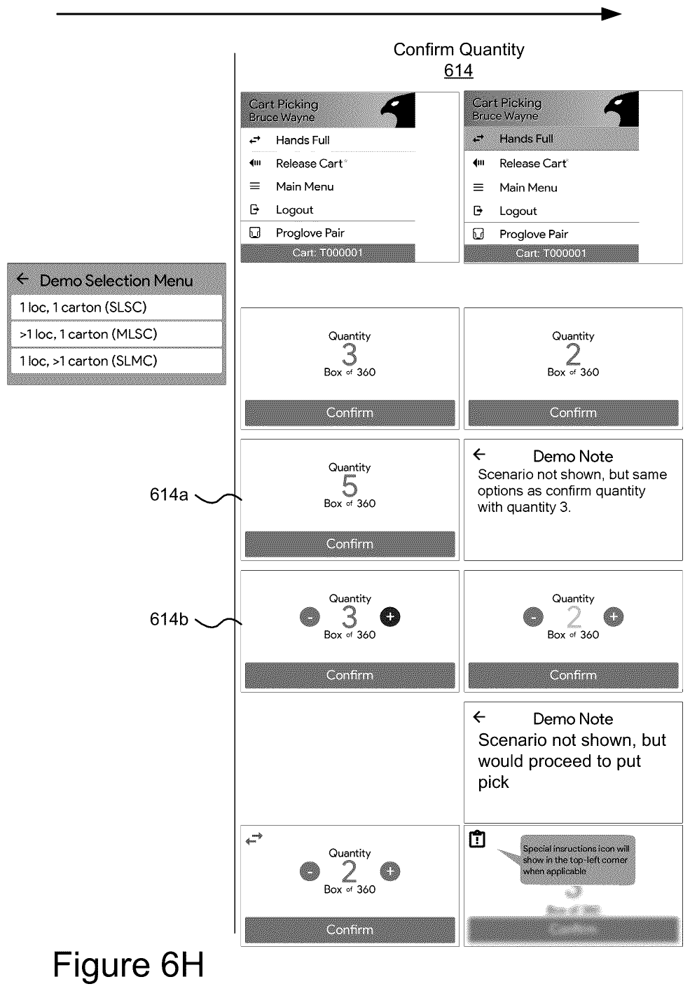

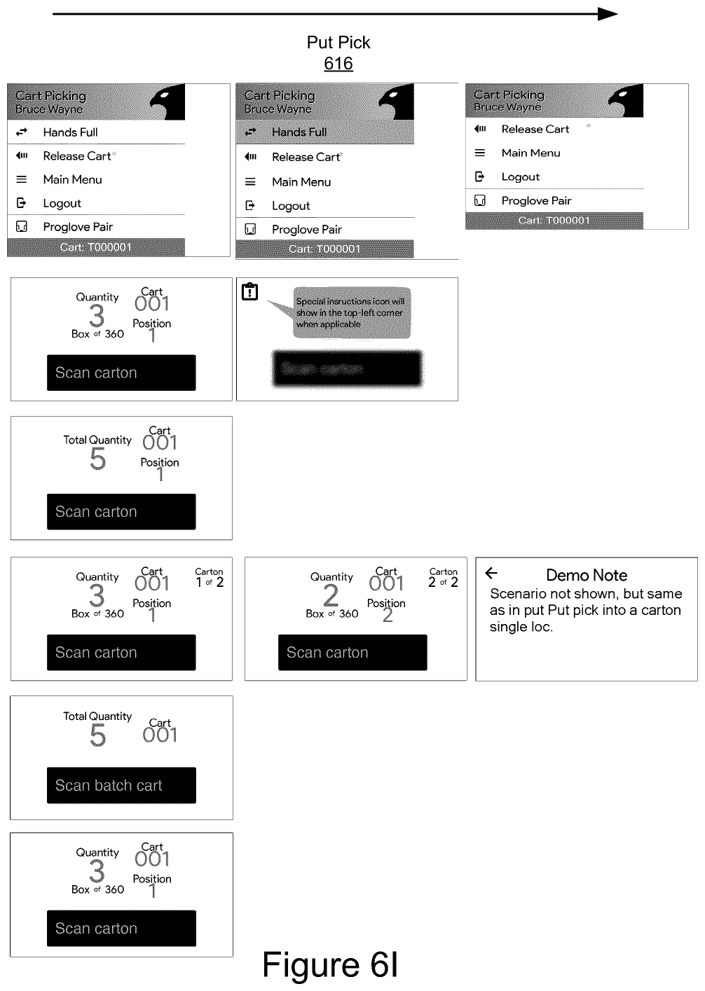

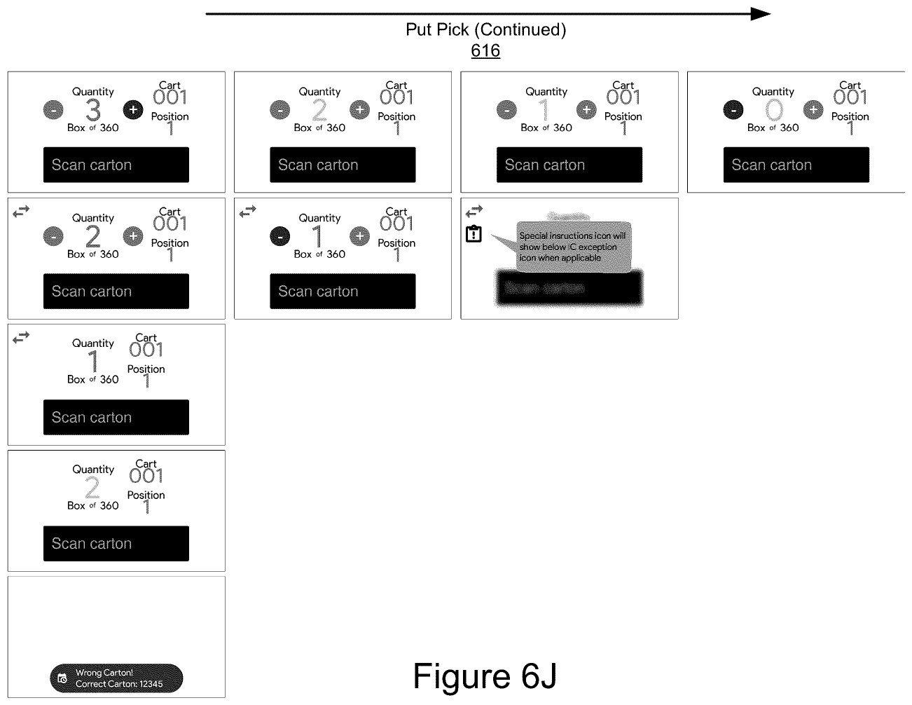

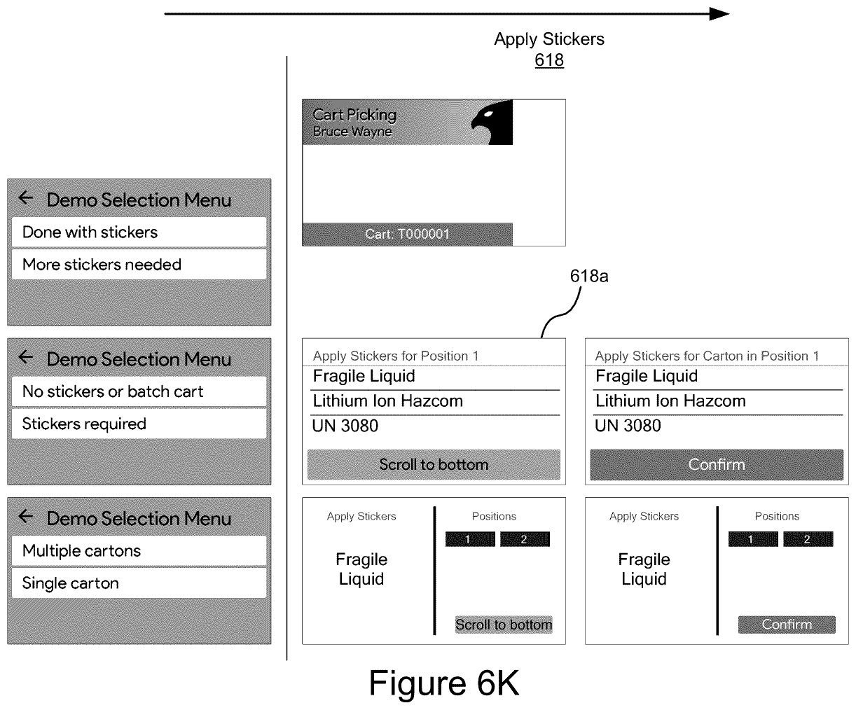

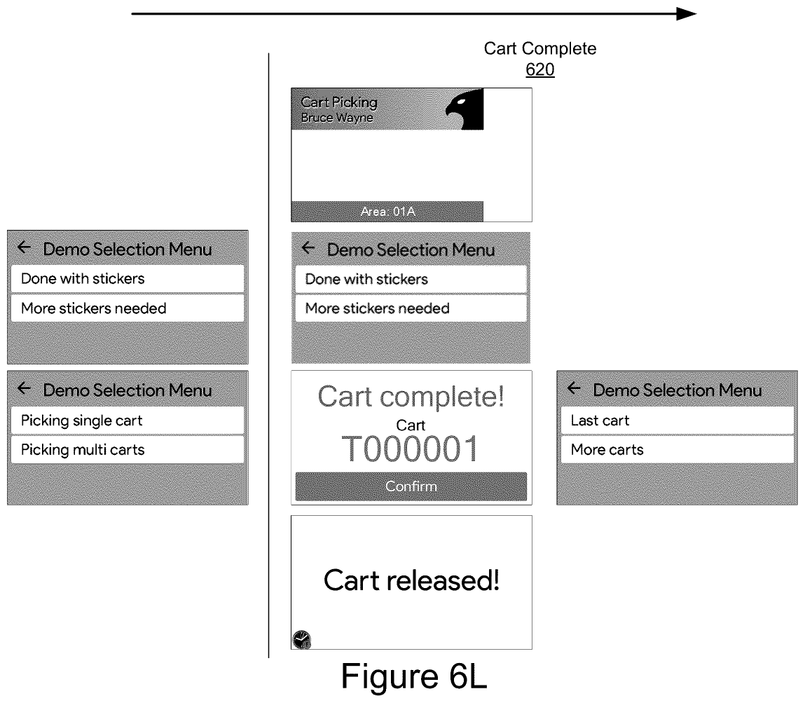

FIG. 2 illustrates a flowchart of an example method 200 for picking according to some implementations of the technologies described herein. It should be noted that although the operations are described in reference to the picking system 108, picking device 158, and/or WMS, they may be performed by various components of the system 100. Similarly, the operations of the method may be modified (reduced, changed, re-ordered, or otherwise) or may be further described elsewhere herein (e.g., in reference to FIGS. 6A-6L).

At 202, the picking system 108 may determine a process flow based on a scan of a label at a work location, for instance, the picking system 108 may determine that items are being received from a delivery door, picked directly into cartons, picked to a cart, a cart is being prepared, or another flow (e.g., of operations and/or interfaces) is to be used based on scan data received from and/or by a picking device 158. For instance, if a label at a finalizing area is scanned, the picking device 158 may display interfaces for a finalizing flow.

In some implementations, in addition to the determined flow, the system may determine and/or provide (e.g., a picking system 108 may send to a picking device 158) one or a series of tasks, such as picking tasks. This data may include item identifiers (e.g., SKUs), barcode information, requested scan data, instructions for a task list.

At 204, the picking system 108 may provide one or more instructions, such as a first instruction to a user to perform a second scan of items(s) via a graphical user interface. In some implementations, the picker's picking device 158 may display an interface indicating the first instruction, such as to scan a product or carton. Depending on the implementation, the instructions and/or interfaces may be streamed to the picking device 158 from the picking system 108, downloaded as a batch, or may be programmed as an on-device application that uses information retrieved by the picking device 158 from the picking system 108 and/or the data store 120. For instance, the picking device 158 may determine the flow based on the scan, and retrieve data for particular tasks, as noted in further detail below.

At 206, the picking system 108 may receive scan data from the picking device 158 for the second scan of one or more items. For instance, a picking device 158 may include or be communicatively coupled with an optical scanner that is activated by a finger gesture of a picker. For instance, the picking device 158 may have a physical or wireless (e.g., Bluetooth™) connection with a separate device, which may be a finger or wrist mounted scanner or handheld scanner. In other instances, the scanner may be integrated with the picking device 158. As noted above, a scanner may be an optical scanner for scanning barcodes, QR codes, etc., or it may scan RFID (radio frequency identification) or other means for identifying objects or labels. When the picker activates the scanner, it may transmit an image, code, or other data to the picking device 158. The picking device 158 may associate the received scan data with its current operation (e.g., that a particular item or UPC is being scanned) and transmit a message indicating the same to the picking system 108, WMS 104, and/or another component of the system 100. It may also update the interface on the picking device 158 to indicate that a scan was received, the identity of the item (e.g., as received by the picking system 108 or WMS 104), or otherwise.

At 208, the picking system 108 (whether at a server level or at the picking device 158) may identify the scanned item(s) based on the second scan. For instance, the picking system 108 may receive the scan data from the picking device 158 and use it to look up a UPC or other identifier in a database and match it to item information. The picking system 108 may update a task list for the picker, picking device 158, carton, cart, or otherwise to indicate that the item has been scanned (or potentially picked, put into a carton, or a task has otherwise been performed). In some instances, with the instruction at 204, relevant information for identifying or confirming item identity or task completion may be received by the picking device 158 with an instruction and/or with a determined workflow from a server level, so that the picking device 158 can locally identify the item(s) based on the second scan. While other implementations are possible, this may provide benefits in latency, bandwidth, complexity, and overall efficiency.

In some implementations, as noted in detail elsewhere herein, the picking device 158 may update the graphical interfaces displayed with each step, scan, instruction, etc. For example, the picking device 158 may indicate that it is waiting for a scan, that a scan was received, that the correct or incorrect item was scanned, a next instruction/step, or otherwise, as noted elsewhere herein. For instance, the process may repeat as multiple items are instructed, scanned, and identified either in sequence or in total, so that a picker may retrieve multiple items in a single trip, such as where they walk to a shelving unit and pick up multiple items before taking them back to the carton or cart.

At 210, the picking system 108 may identify a carton based on a third scan of an item. For instance, the picking system 108 and/or picking device 158 may automatically display carton information directing a picker to place the identified items in an identified carton. The carton information may include a tag, location, label or otherwise and be displayed on the picking device 158 that performs scans, on a pick-to-light system, via audio queue, or otherwise. The scan of the carton may be of a label, bar code, QR code, RFID, etc., on the carton and may be processed in the same way as noted above and respective to the other scans described herein.

It should be noted that other implementations are possible, such as where the determined workflow (also referred to as a process flow) may cause the client device to display an instruction to the user to scan a carton first, identify items for the scanned carton, receive confirmatory scans of the items, and/or then receive a scan of the carton.

At 212, the picking system 108 may associate the identified item(s) with the identified carton(s) based on the third scan. For example, the picking system 108 may automatically update a file associated with the carton to indicate that the item has been placed into the carton in order to confirm a correct pick or quantity thereof (as noted below).

At 214, the picking system 108 may receive an input verifying a quantity of the item(s) via the picking device 158. For instance, the picking device 158 may display an interface via which a quantity may be entered or incremented up/down. The picking system 108 may receive communication from the picking device 158 indicating the quantity and update the file for the carton to indicate the quantity. In some implementations, the quantity of the item instructed to be picked may be pre-selected or displayed and the user may update or confirm it via the interface, gestures, or scan(s) (e.g., of the carton or otherwise).

At 216, the picking system 108 may update a graphical user interface based on the association, input(s), and/or scans. For instance, the interface displayed on the picking device 158 may indicate completion of a pick, of a carton, or other details, such as carton status, cart status, or further instructions.

In some implementations, once a pick is completed at a location, the picking system 108 may instruct the user to move to a new location and issue a new instruction or set thereof. In some implementations, once a pick is completed for a carton (e.g., at a pick station), the picking system 108 may issue instructions for a subsequent carton or set thereof. Other implementations are possible and contemplated herein.

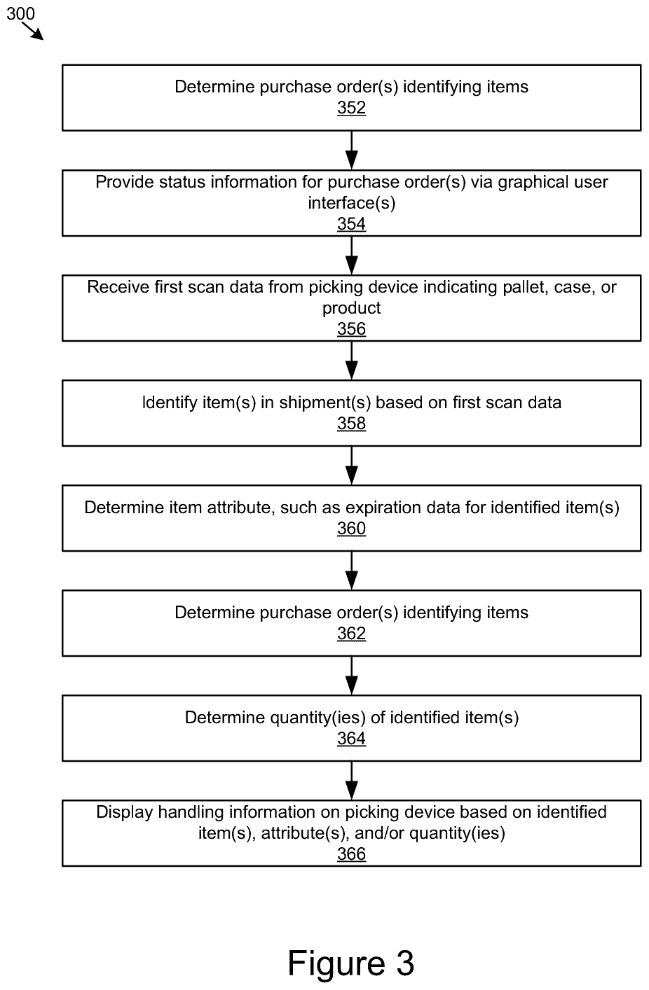

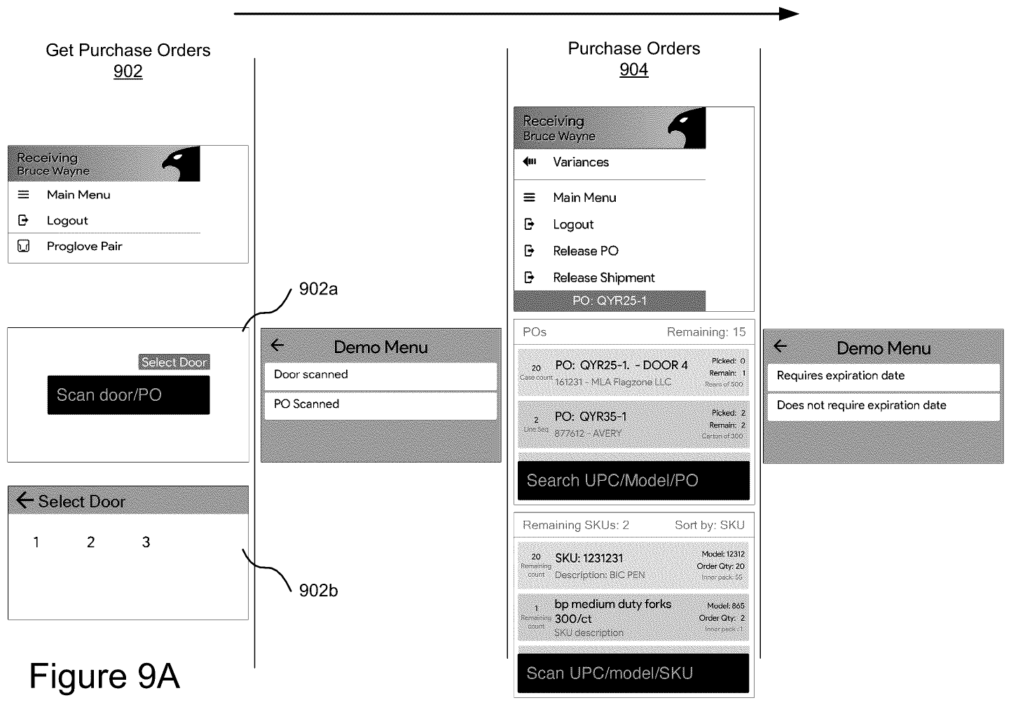

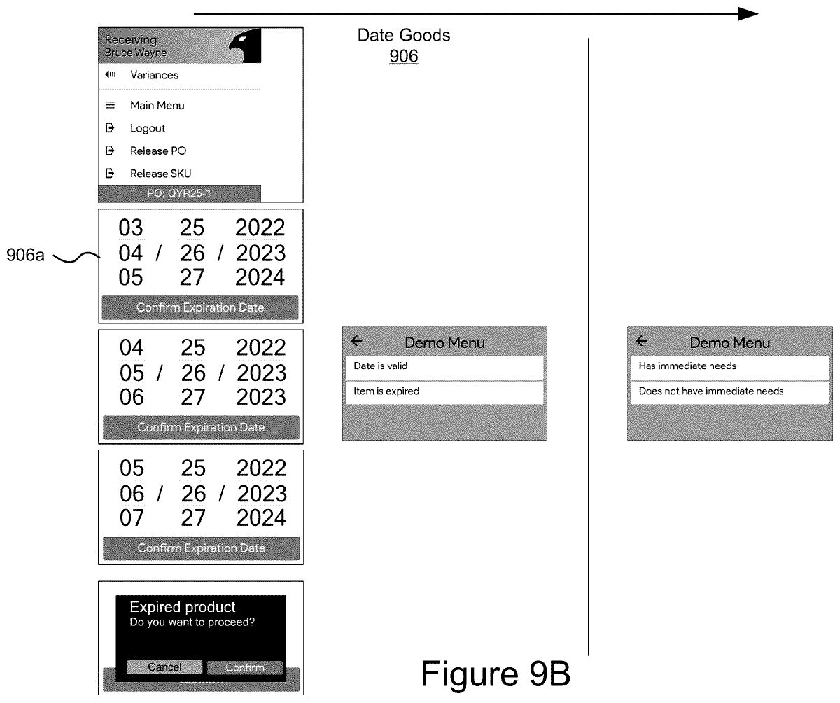

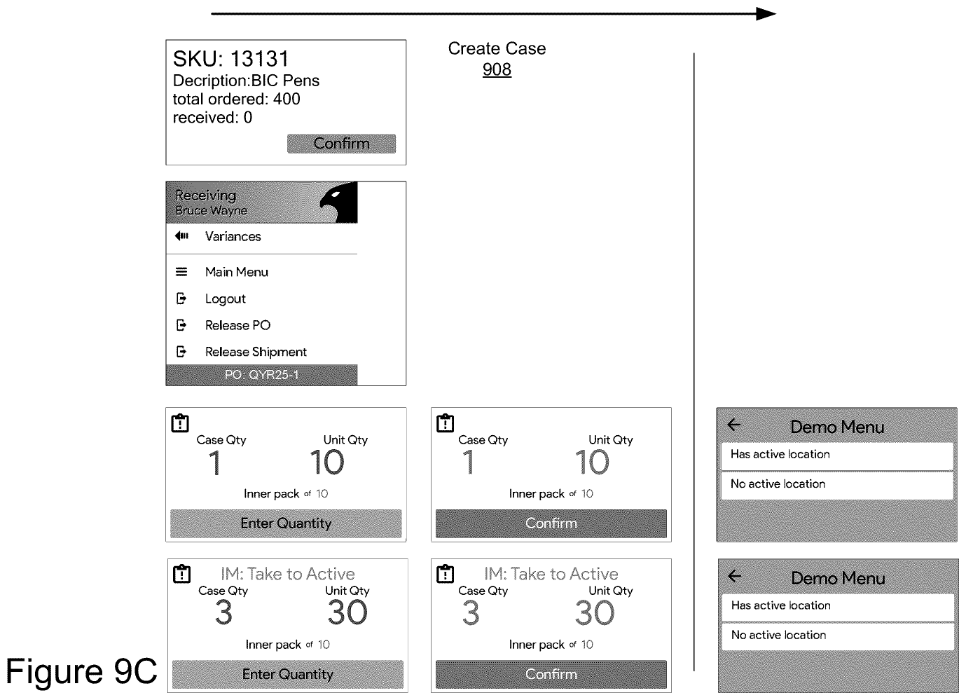

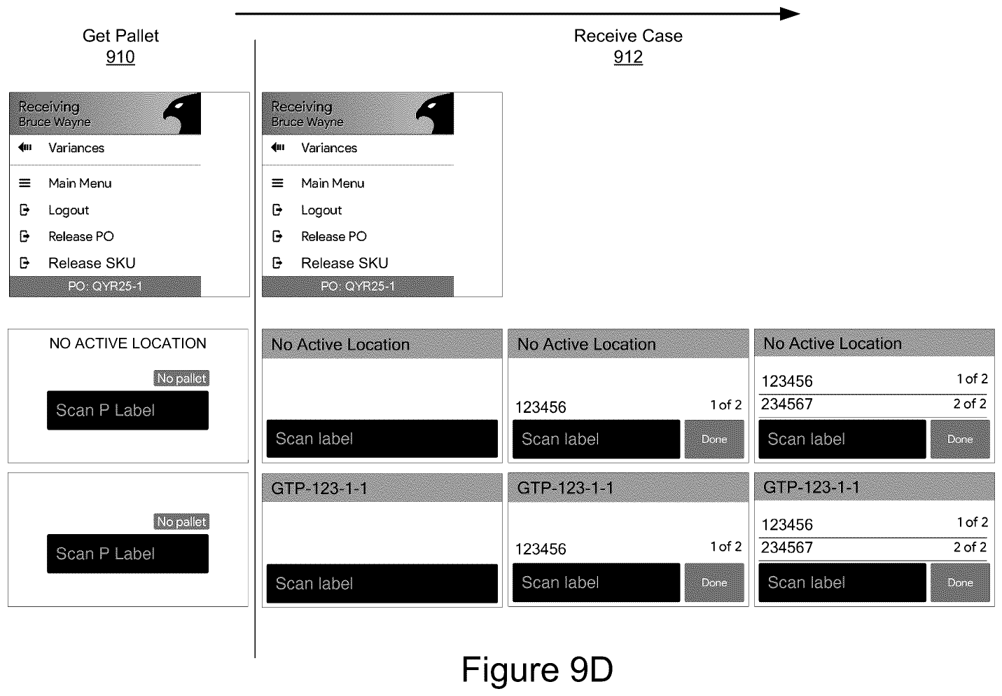

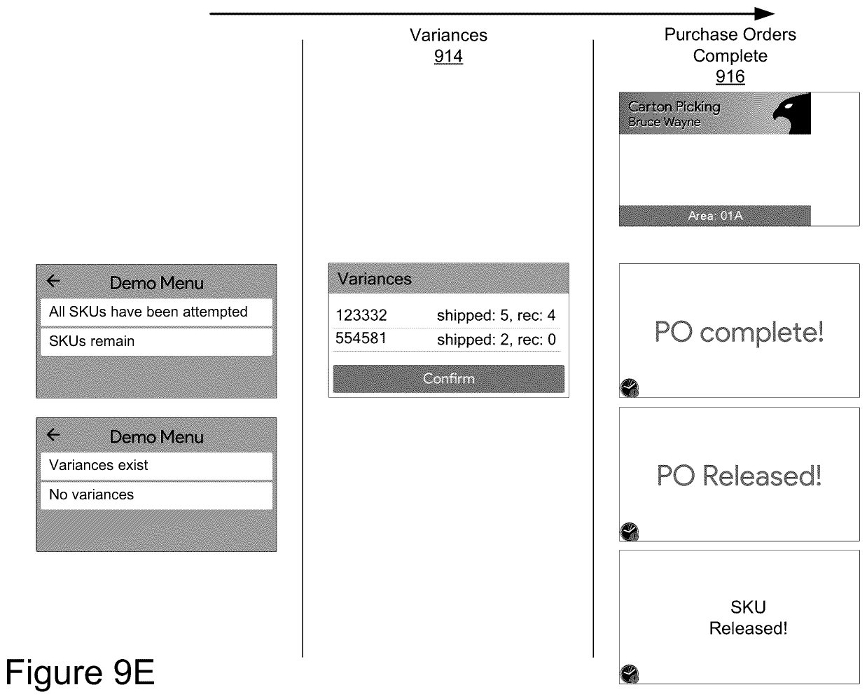

FIG. 3 illustrates a flowchart of an example method 300 for receiving (e.g., receiving items into a fulfillment center) according to some implementations of the technologies described herein. It should be noted that although the operations are described in reference to the picking system 108, picking device 158, and/or WMS 104, they may be performed by various components of the system 100. Similarly, the operations of the method may be modified (reduced, changed, re-ordered, or otherwise) or may be further described elsewhere herein (e.g., in reference to FIGS. 9A-9E).

At 352, the picking system 108 may determine one or more purchase orders identifying items. For instance, the picking system 108 may determine a set of items expected in one or more shipments. The determination may be based on a scan of a pallet, door, or truck, or based on picker input, such as where a user selects a purchase order from a list or enters an identifier for it (e.g., via a picking device 158). In some instances, the picking system 108 may determine various details of the purchase order, such as expected items or otherwise.

At 354, the picking system 108 may provide status information for the purchase orders via one or more graphical interfaces on a picking device 158. For instance, the picking device 158 may receive status information from a data store 120 and/or a picking system 108, and it may display the status information. For instance, the picking device 158 may display a list of purchase orders where the list is color coded based on status or other attributes, so that the user can quickly ascertain status information in a small screen device, although other implementations and possible and contemplated herein.

At 356, the picking system 108 may receive first scan (as noted elsewhere herein, “first” may indicate an order or it may merely distinguish one scan from another without necessarily indicating that it is the first scan) data from a picking device 158 for a scan of a pallet, case, or product. For instance, the pallet, case, or product may be received in a shipment and the first scan data identifies to the picking system 108 which pallet, case, or product was received, so that it can update a file for the picking order to indicate receipt of that/those item(s). In some implementations, the picking device 158 may scan a label on a pallet and, based on local data or in communication with the picking system 108, WMS 104, or data store 120, identify a particular purchase order and/or determine that the pallet belongs to a particular purchase order.

At 358, the picking system 108 may identify item(s) in the shipments (e.g., on a pallet or truck) based on the scan data. For instance, the picking system 108 may receive scan data from a picking device 158 (which may receive it from a scanner) and match it against a database of products to identify the item(s) scanned.

In some implementations, at 360, the picking system 108 and/or picking device 158 may determine an item attribute, such as expiration data for the identified item(s). For example, the picking device 158 may request an input from the picker indicating the expiration date and/or serial number (or it may automatically be determined from a scan or image captured by a picking device 158). In some instances, other information may be determined, such as whether another pick in a pick queue requires the item or the item is needed in another pick in the warehouse being performed or being held for the item. The picking system 108, WMS 104, or other systems may determine a heightened priority for the item (based on expiration date, an outstanding order or pick task requesting the item) and send an instruction to the picking device 158 (and/or to an AGV 114 or other device) prioritizing handling, reception, or storage of the prioritized item. If no expiration date is applicable for the identified item (e.g., for paper, pens, etc.), the picking system 108 may skip displaying the interface(s) requesting scan or other input, which improves computational efficiency and efficiency of using the interface(s).

At 362, the picking system 108 may determine the purchase order for the identified item and update a corresponding file in the data store to indicate that the item has been received for the determined purchase order. In some implementations, as each item is identified (e.g., here or at 356), the picking system 108 may update a computer record describing the shipment and/or identified purchase order to indicate that an item and/or quantity thereof has been received. In some instances, the record, inventory, or other data (e.g., item data 130, pick task data 132, or otherwise) may be updated to identify an unexpected (e.g., not on the purchase order) item received in the shipment.

At 364, the picking system 108/picking device 158 may determine a quantity of the items, for example, based on a quantity of items in a scanned case, a quantity of scans of the item, or based on a user input into the graphical interface on the picking device 158.

At 366, the picking system 108 may display handling information on the picking device 158 based on the identified items, attributes, and or quantity. For instance, the picking device 158 may display an instruction to the picker to place the item in a certain mini pallet, on a conveyor, in a carton, or otherwise. The picking system 108 may also track tasks and indicate to the picker that the tasks or purchase order/shipment are complete. In some implementations, as items are identified, the REX 134 may instruct one or more AGVs 114 to transport empty or other mobile storage units to the location of the shipment and/or to a replenishment area to receive the item(s). The picking device 158 may scan the items and/or mobile storage unit as the items are placed therein to associate them together. In some cases, the AGV 114, conveyor, or other device may transport the mobile storage device to or from the shipment location or replenishment area.

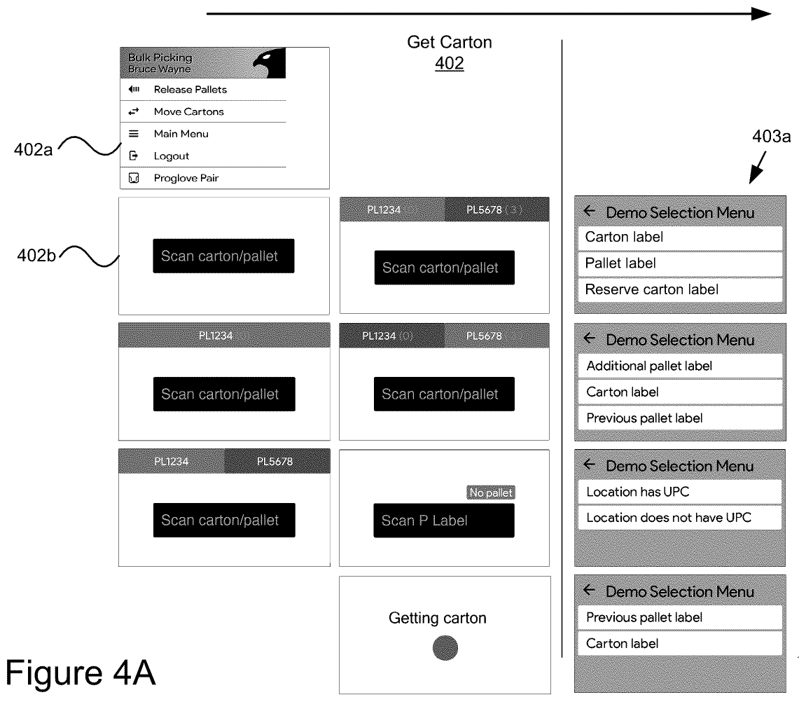

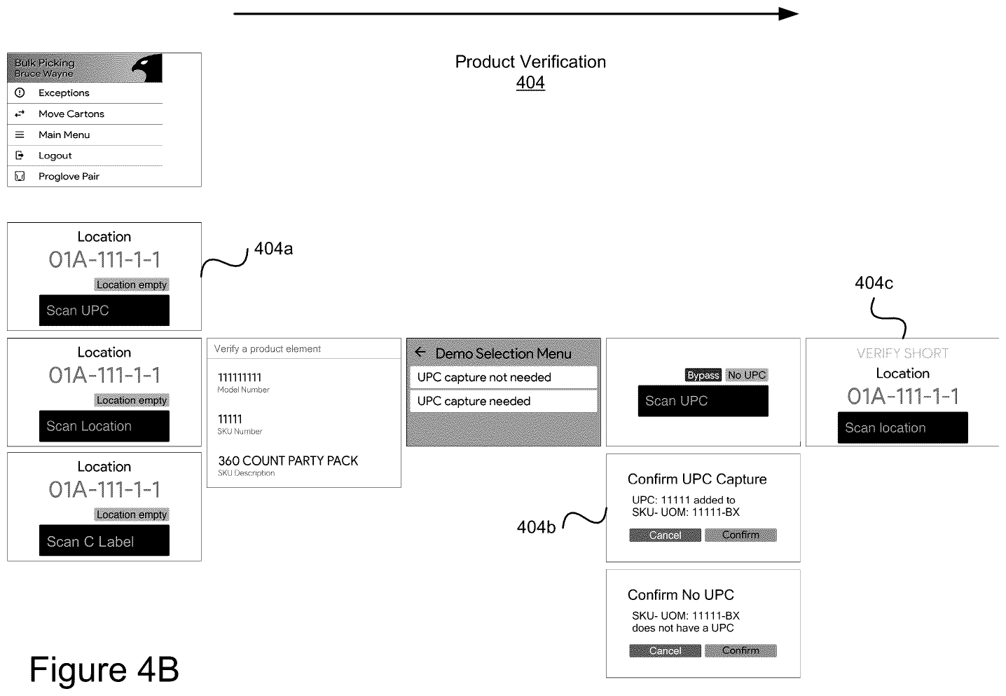

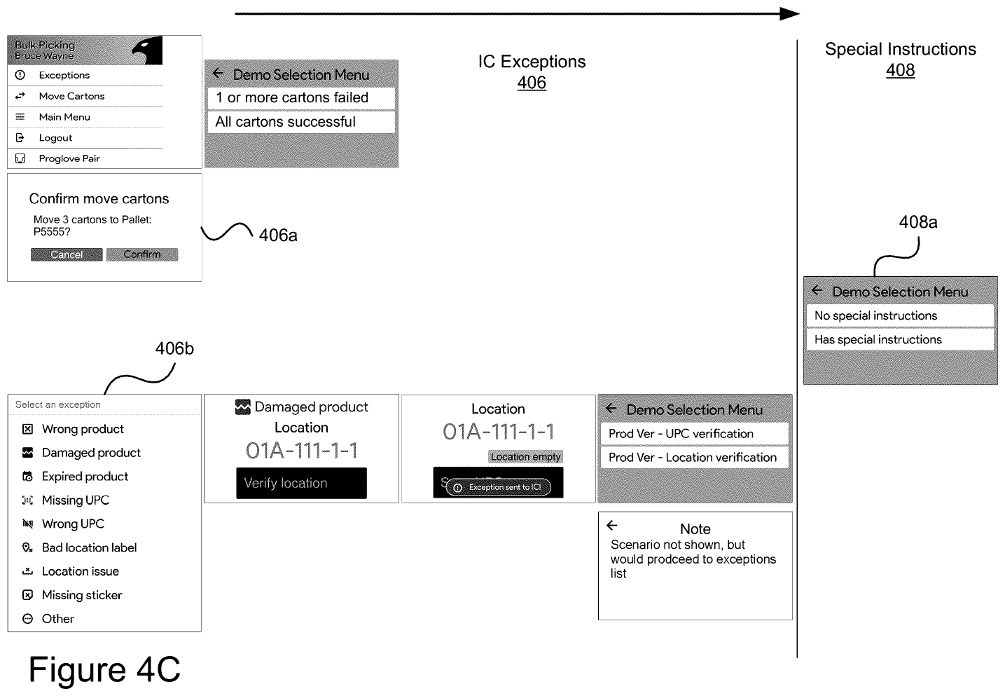

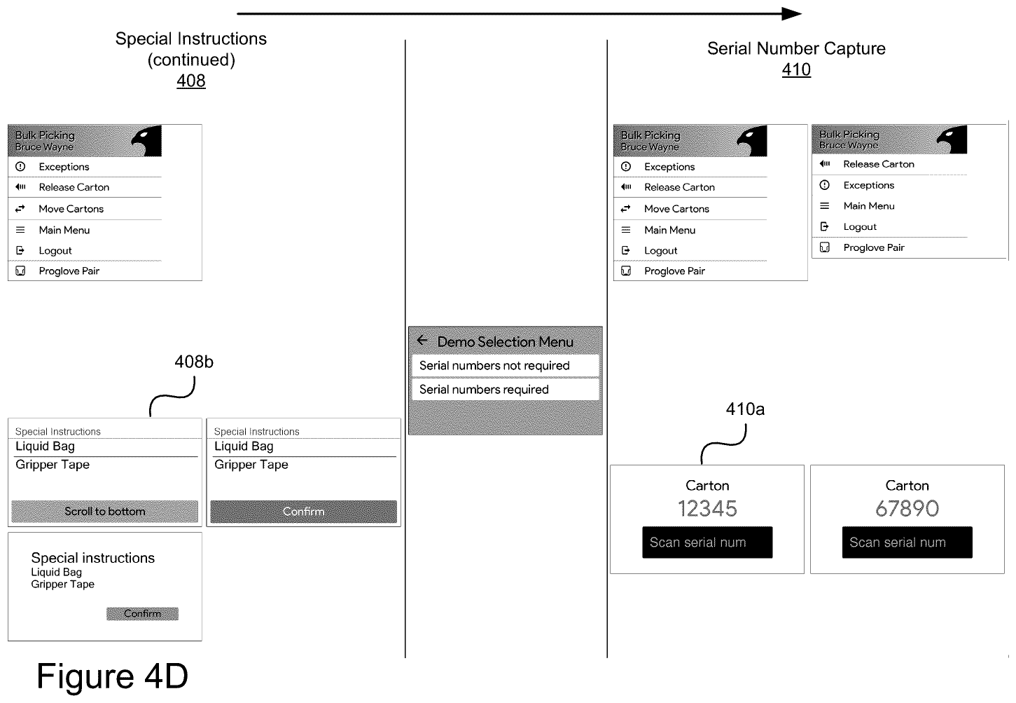

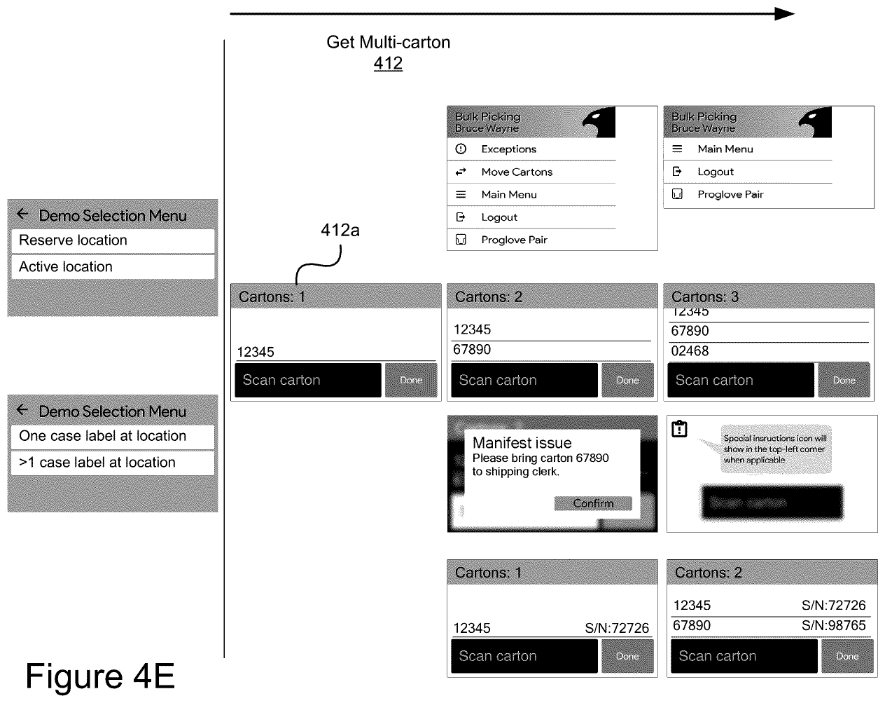

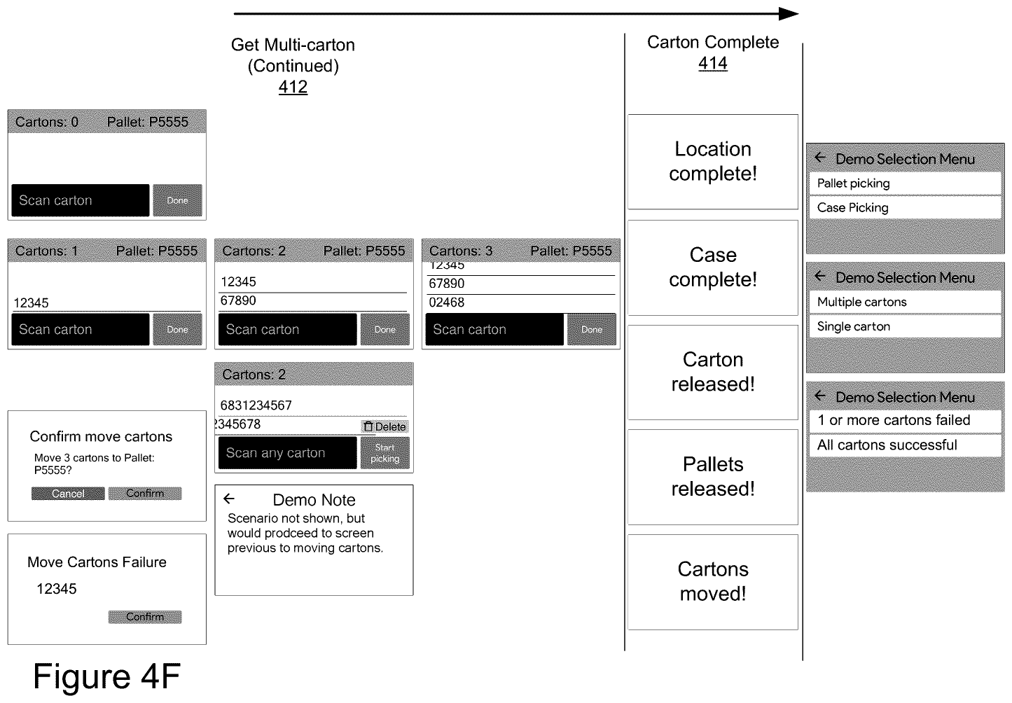

Regarding FIGS. 4A-10E, alternative, similar, or related screens are generally illustrated between vertical subdivisions. These progressions show sequential steps; however, it should be noted that, in some implementations, the order, arrangement, or other details of these steps and features may be different without departing from the scope of this disclosure. The flowcharts illustrate a number of blocks, which may represent or correspond to logical operations and/or graphical user interfaces. For instance, certain operations displayed in graphical interfaces or otherwise illustrated/described may correspond to programmatic or other operations executed, such as communication between sensors, picking devices 158, the picking system 108, the WMS 104, or otherwise. Further, it should be noted that the processes here may represent single or limited applications, but they may be performed recursively to process many items.

It should also be noted that although certain operations are described in reference to certain components of the system 100, they may be performed or processed differently. For instance, some operations may be processed on the picking system 108/server or on the WMS or another component of the system. For instance, a picking device 158 may scan a label and then communicate directly with the WMS to perform operations instead of using the picking system 108/server as an intermediary.

The operations, for simplicity may be described as being performed by a picking system 108, but they may be performed directly on a server of the picking system 108, on a picking device 158, or based on communication between the picking device 158 and the server of the picking system 108. For instance, a task list, label identifiers, or an entire workflow may be downloaded to a picking device 158, which may perform some or all of the operations independently or it may send and receive information to/from a server of the picking system 108 or another component of the system 100 to determine task information, confirm completion of tasks, coordinate with other pickers and devices, or perform other operations, such as those described herein.

FIGS. 4A-4F illustrate an example series of graphical user interfaces that represent a workflow or process flow for a bulk picking method, according to some implementations. For instance, the workflow may be used to pick multiple items together. The flow provides a series of steps that are illustrated moving from the left to right through FIGS. 4A-4F. Additional or alternative graphical interfaces are also shown vertically. For instance, groups of graphical user interfaces may be grouped into steps for purposes of the description herein. In some cases, within a division or step described, the picking device 158 may transition vertically or horizontally depending on an input into the graphical user interface or a scan (e.g., of a label item, etc., as described elsewhere herein). Other directions or movements withing interfaces may also be performed without departing from the scope of the description herein.

The flow allows a picker to pick a bulk item or set of items, order, or pallet and, using the illustrated features, the picking system 108 may track, assign, and confirm tasks, among other operations illustrated. For instance, multiple cartons can be scanned, pallets or cartons can be switched in the interface, tasks can be switched, etc. For instance, a picker may add a pallet by scanning a pallet label, remove the pallet by scanning the label again, or add another pallet by scanning another pallet label. Accordingly, the task list and graphical interfaces can be quickly, easily, and automatically updated.

The picking system 108 may use colors to indicate an active pallet, active task, quantity of cartons, type of task, etc. For instance, as illustrated at 402, top bar may be blue or another color to indicate an active pallet where multiple pallets are selected and a user may scroll sideways or scan a pallet to change the active pallet. Additionally, certain boxes may be rendered with a blue background to indicate that they include logical options for operations for illustration. Depending on the implementation, these boxes or interface may not be displayed on a picking device 158. Other text, graphics (e.g., text boxes, tabs, buttons), and backgrounds may be colored to indicate status of the interfaces and/or tasks. Distinctions are shown herein as varying shades or contrasting regions for purposes of illustration.

At 402, the picking device 158 may display one or more interfaces that request that a carton be scanned, and, based on which, receives scan data, for example, of a pallet or carton. The picking device 158 may transmit the scan data to the picking system 108 and/or WMS, which may determine a carton, pallet, product, or otherwise, as illustrated.

As illustrated, a menu interface 402a may indicate that a user is logged in while allowing basic operations, such as releasing pallets, moving cartons, accessing a main menu, logging out, or pairing a scanner (e.g., a Proglove™). In some instances, an interface 402b may be shown with a quickly recognizable instruction (e.g., scan carton/pallet). Additional interfaces may be displayed or the interface 402b may be updated as the user performs scans. For instance, the interface may update to indicate an identified pallet, carton, or purchase order in a top bar and/or in one or more tabs thereof. A count of scans or other details may also be shown in the top bar. In other instances, the interfaces may indicate whether a carton or pallet was found, or other instructions.

In some instances, based on a selection of a menu button, a top bar, or a gesture (e.g., a swipe or a wrist flick), one or more menus or verification screens 403a may be displayed. These menus or verification types may vary depending on the interface, instruction, or scan from which they were accessed or surfaced. For instance, these interfaces 403a may allow access, display, or input (e.g., via a scan) of a carton label, pallet label, reserve carton label, additional pallet label, etc. Similarly, they may allow a user to indicate an error or exception or further navigate, such as by indicating that a location has or does not have a UPC (universal product code) or otherwise move between pallet or carton labels.

These and other interfaces may be designed to reduce distractions and allow extremely quick recognition of tasks and progress through the flow. For instance, they may progress through the flow based on a screen tap, gesture, or scan with limited options or ambiguity.

At 404, the picking system 108 may verify a product, for example, by receiving scan data of a UPC from the picking device 158, receiving a scan of a location, or other operations. As noted above, in some implementations, where multiple of the same item are being picked a picker may use a picking device 158 to scan the item again without verifying the product again.

For instance, one or more interfaces 404a may identify a location, allow a user to indicate that the location is empty, instruct the user to scan a UPC, location, or carton label, and/or it may receive scan data thereof and automatically associate it with the requested action. Other interfaces may display or receive verification information, skip a scan or item, or allow additional scans. For instance, an interface 404b may confirm UPC capture that there is no UPC or otherwise. In some instances, a user may indicate that there are an insufficient quantity of items (e.g., a short pick) and the picking device 158 may receive a scan of the location (e.g., an empty location), which allows it to verify and track items for replenishment or exceptions to pick tasks, for example, as illustrated in the interface 404c.

At 406, the picking system 108 may determine exceptions or other attributes for an identified product, for example, by communicating with a database coupled with the WMS 104. For example, the picking system 108 may determine that a wrong product was scanned (e.g., that should not be in a pick, pallet, carton, order, etc.), that a scanned product is expired, at the wrong location, or otherwise. In some implementations, the user may indicate (e.g., via a menu, as illustrated) to move cartons and the picking device 158 may display an interface 406a that confirms that the user wishes to move cartons, for example, to an identified (based on active interactions with it, a scan, or other input) pallet.

In some instances, an interface 406b may allow a user to identify an exception to a pick a pick. Responsive to a selection of an exception, other interfaces allow the user to scan a location or label of a damaged product, a missing product, or other exceptions, for example, to identify or verify the item or task for the exception. Accordingly, the user and picking system 108 may quickly and while reducing data-entry and other errors input and track exceptions, which may be processed by other systems or agents to address the exceptions, update corresponding orders, etc.

If there are exceptions or special instructions, they may be displayed (e.g., at 408) in an interface 408a and the task may be determined or modified. For instance, the interface 408b illustrates an interface via which a user may select or via which the picking device 158 may display special instructions. The user may scroll to view more instructions, confirm the instructions, or perform other operations. If there are no exceptions, the process may proceed.

In some instances, at 410, if further verification or definition is required for a UPC, the system may request an entry or scan of a serial number for the product (e.g., on an item or carton) in an interface 410a. For instance, certain products (e.g., Apple™, HP™, etc.) may require additional data in the form of a serial number of each product and, in such cases, the picking system 108 may request the serial number. For example, the picking system 108 may parse a file associated with the identified item(s) to determine a flag requesting or requiring a verification scan. Additionally, as shown in 410, while the interfaces typically are very simple with single or simplistic output/inputs, a menu or other options may be displayed (e.g., by swiping from a touch screen side).

At 412, the picking system 108 may get multiple cartons. For example, a picking device 158 may scan multiple cartons, which causes the interface to display carton identifiers for each carton and update the task list and files associated with those cartons, as described above. For instance, a first quantity of the identified UPC/product may be placed into a first identified carton and a second quantity of the identified UPC/product may be placed into a second identified carton. The scans of the cartons, as well as the interfaces, quickly and efficiently confirm these picks. In some instances, by scanning the cartons again or selecting an option on the interface, a picker may move items to a pallet or carton or perform other operations. In some implementations, if a carton is selected on the interface, corresponding UPCs that should be picked or have been picked to the carton may be displayed.

For example, one or more graphical user interfaces 412a may display an instruction to scan a carton and, as the user scans the labels, their identifiers may be added to a list on the interfaces 412a. In some instances, exceptions or special instructions may be displayed in popup windows or information elements. In some instances, serial numbers may also be scanned, determined, or otherwise added and/or displayed. The cartons may also be associated with a pallet that was previously or subsequently scanned, which information may be displayed in a top bar. In some cases, a user may request and confirm moving cartons, delete cartons, or perform other actions, as illustrated in the example interfaces.

The picking system 108 may track the products in a bulk carton or pallet to determine how many are left, the products picked into each carton, order fulfillment process, order-fulfillment tasks or sub tasks, or otherwise. For example, the picking system 108 may determine when the correct products or number of products have been picked to a carton and determine that the carton is complete. At 414, the picking system 108 (e.g., via the picking device 158 updating a graphical interface), may display a graphical element indicating that a location, case, carton, pallet, etc., are complete or released, though other implementations are possible. Verification or other menus may additionally be displayed, for example, to allow pallets or cases to be picked, multiple or single cartons to be selected, or to indicate a failure or success of a carton scan.

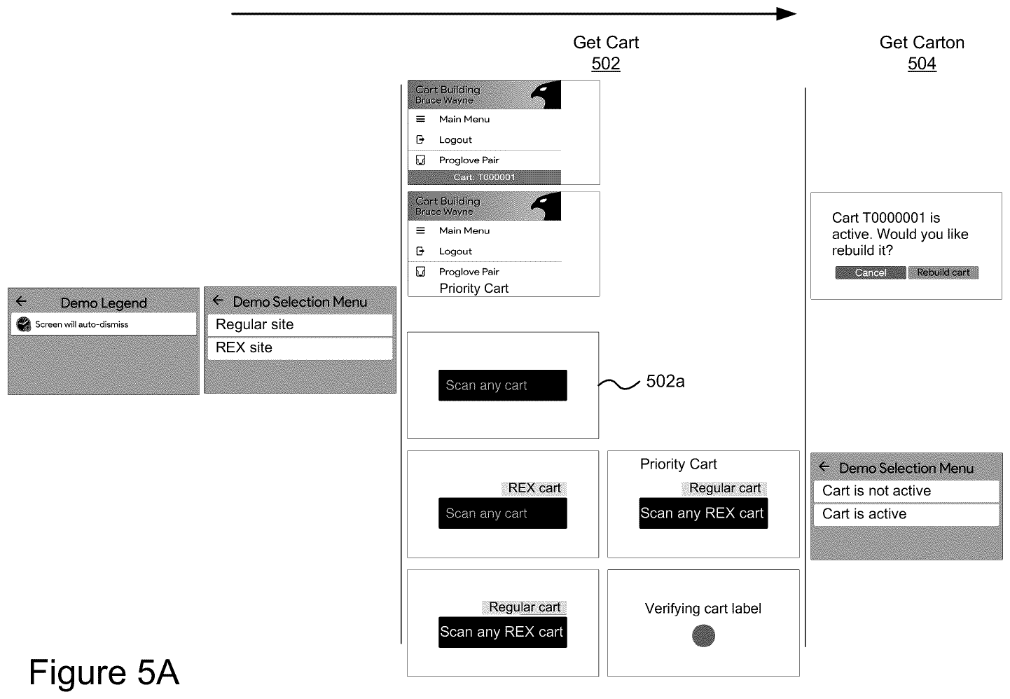

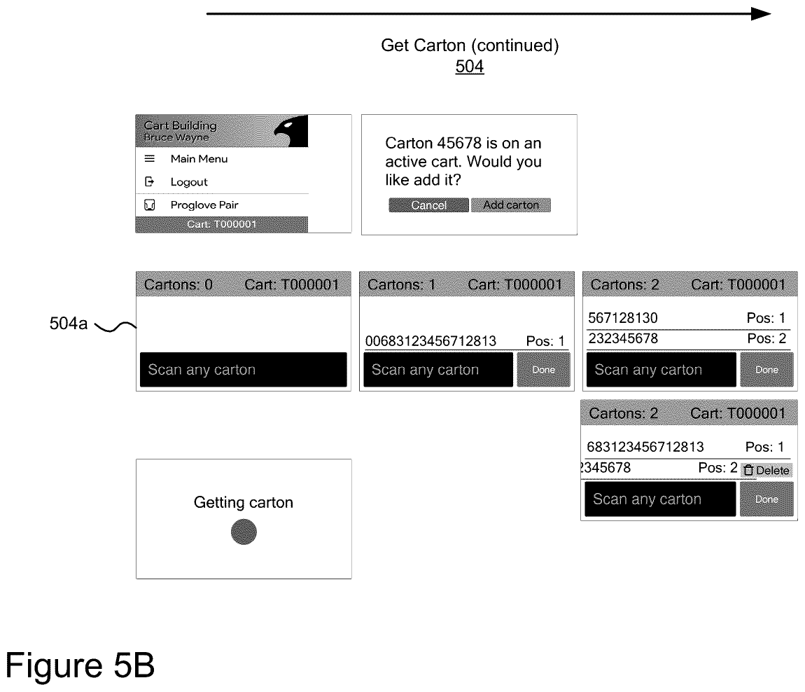

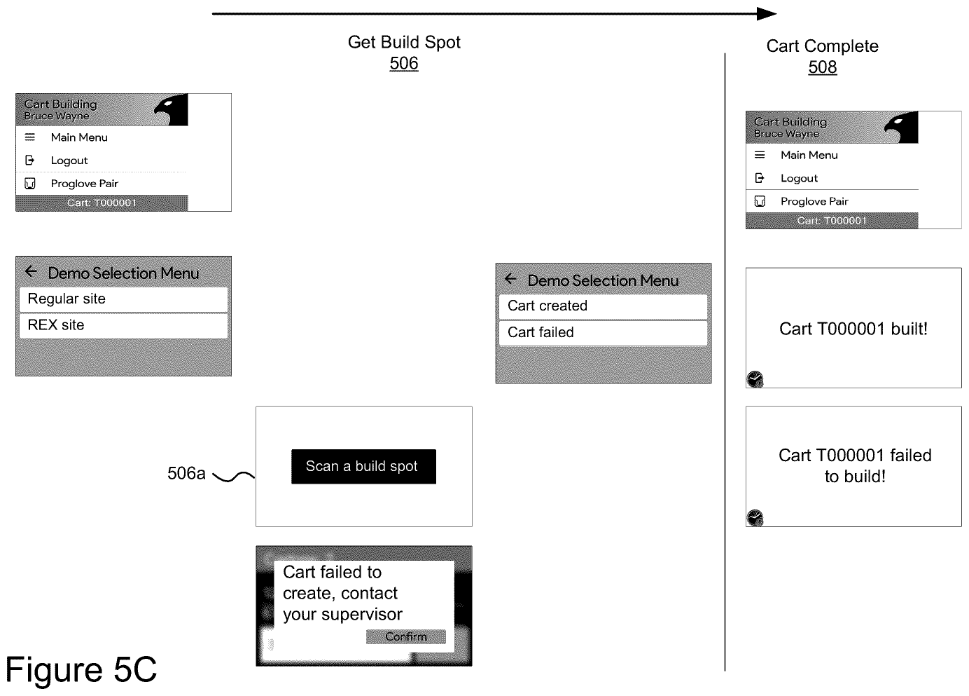

FIGS. 5A-5C illustrate an example workflow for an example method of building a cart, for example, where a cart carries multiple cartons into which items may be picked, the method may describe associating cartons and a cart. The picking system 108 may determine the process flow or set of operations, for example, based on a scan, assignment, or selection on the graphical interfaces. For example, the set of operations (and corresponding interfaces) to use may be determined based on a fulfillment center type, a determined location, a determined cart, or otherwise.

At 502, the picking system 108 may determine a cart that is being built, for example, by providing an instruction on an interface 502a to scan a cart and receiving corresponding scan data. The system may further determine subsequent steps based on the specific cart, location, cart type, etc., scanned. For instance, a robotic cart (or cart transported by an AGV 114), priority cart, or otherwise may be handled differently, depending on the implementation. As illustrated in the example of step 502, the picking device 158 may instruct, allow, or receive scans of any of these various types of carts, which may affect the flow as it moves forward or orchestrations of other devices, such as AGVs 114 in the fulfillment center in association with the flow.

At 504, the picking system 108 may determine one or more cartons, for example, by requesting (e.g., via the graphical interface(s) 504a on the picking device 158) and receiving scan data. For example, the picker may use the picking device 158 to scan one or more cartons, which may cause the picking device 158 to automatically update the interface(s) to indicate the cartons and to associate the cartons with the cart in a database (e.g., data store 120). As noted above, these interfaces and inputs may be very simple to improve efficiency on a limited display-sized portable device with limited processing capabilities, while also improving accuracy (e.g., where instead of data entry or physical selection, scans of barcodes, etc., are used).

In some implementations, the picking system 108 may perform backend error checking, for example, to compare cartons assigned to or scanned by various picking devices 158 to ensure that another picker is not using the same carton or performing redundant tasks.

At 506, the picking system 108 may determine a build spot, which may correspond to a work location or other location where the cart is located. The identification of the build spot may be transmitted to the dispatch system, REX 134, or WMS 104, for instance, which may assign an AGV 114 to the cart and instruct the AGV 114 to travel to the build spot to couple with the cart and move it within the warehouse/fulfillment center. Accordingly, in some implementations, an AGV 114 may be automatically associated, a task updated, and an interface updated based on a simple scan by a picking device 158.

In some cases, the picking device 158 may allow a user to select a cite, such as a regular or robotic (E.g., REX) site, and then display an instruction screen/interface 506a that causes the picking device 158 to be able to receive and associate scan data of a build spot, such as a label at a build spot at which a cart is built or filled with cartons for picking, for instance, in a pick-to-cart area of the fulfillment center, although other implementations are possible and contemplated. In some instances, the picking device 158 may indicate that a cart failed to create or may request input from the user indicating whether the cart was created or failed.

In some implementations, the picking system 108, or the picker using a picking device 158, may indicate that the cart is complete at 508. For instance, one or more graphical user interfaces may be displayed indicating that the record for the cart is built in the database or picking system 108 or that its build has failed.

FIGS. 6A-6L illustrate an example workflow of an example method for picking to a cart, according to some implementations. For instance, once a cart has been physically prepared (e.g., as in FIGS. 5A-5C) with cartons and/or associated with a set of cartons in a database, orders may be associated with the cart and/or cartons on the cart, so that items in the orders may be picked into the correct cartons. These figures show various legends, interfaces, notes, and flows. As noted above, these may vary and may generally represent movement between interfaces in a left to right orientation, though the picking device 158 may transition between interfaces in various manners and based on different inputs or scans, as noted elsewhere herein. Furthermore, as noted elsewhere herein, the operations may refer to a picking system 108 but may be performed directly on a picking device 158, on a server of the picking system 108, or in combination between devices.

At 602, the picking system 108 may instruct a picker to move to any or a defined work area. A graphical interface 602a may receive a user input or other scan identifying a location or work area. Additionally, or alternatively, when a picker scans a label at a location while on the graphical interface shown at 602, the picking system 108 may automatically use the scan data to associate the location with the picking device 158. In some instances, the picking system 108 may automatically determine a workflow/process (e.g., that a cart is being picked) based on the scan of the location, determine a cart associated with the location, or perform other operations, such as determine a task list for the user, such as for picking to a cart. In some implementations, the picker may use the graphical interface to further define the cart, select multiple carts/locations, or otherwise. As illustrated in the example interfaces, the picking device 158 may display groups or work areas, which the user may select to indicate corresponding details for the workflow or tasks. In some cases, as in the interface 603a, the picking device 158 may allow the agent to select to perform tasks for either a single cart or multiple carts.

At 604, the picking system 108 may determine a cart, for example, as a confirmation of a cart at a location (e.g., as associated in FIGS. 5A-5C, as transported by an AGV 114, etc.), or other determination of a cart. For example, the picking device 158 may scan one or more carts to add them to a pick list and an interface for the picking device 158 and picker. For instance, as multiple carts are scanned in multi-cart picking, their identifiers may be added to a list on the interfaces.

Based on the cart(s) that are determined, the system may create a task list for the user for the orders/cartons on the cart(s). The picking system 108 may send task instructions, such as instructions identifying locations, products, or other items to pick to a picking device 158.

For instance, at 606, the picking device 158 may display a pick location and receive a scan of the location, UPC of the item, or receive other information to verify the identity of the item picked/being picked. For example, the picking device 158 may direct a picker to pick an item from a particular location to a carton in an interface 606a. As noted elsewhere herein but omitted in some instances to avoid over repetition, the picking device 158 may receive scan data of a location, confirm the location, and, in response, display a subsequent interface, such as interface 606b, which request and receives a scan of an item. For example, the picker may then use the picking device 158 to scan the item, which allows the picking system 108 to automatically verify its identity. In some instances, the picking system 108 may request that the picker confirm a UPC, SKU, serial number, or other identification information in other interfaces. The process may repeat for subsequent locations, items at a location, cartons, carts, tasks, or otherwise.

Other interfaces may be displayed to allow item scans to be skipped, item attributes or identity to be confirmed, or shorts to be identified, for instance. For example, if there are an insufficient quantity of an item for an indicated pick, the user may provide an input in an interface indicating an insufficient quantity or may scan the location again to indicate a short of that information, for instance, as illustrated in the interface 606c.

At 608, the picking system 108 may use the determined product identifier to check for exceptions or other item/product attributes, for example, by communicating with a data store 120 or WMS 104, or other system. For example, the picking system 108 may determine if the product is the wrong product for the carton/cart, if it is expired, or has other issues, as illustrated. In some implementations, a user may provide input in an interface 608a indicating an exception for a task. For example, a picker may indicate that the product is damaged, which flags the item or location in an associated data file in a data store 120 for processing by other pickers or devices. Where multiple items are being picked into a certain carton, the graphical interface(s) may allow a picker to indicate that their hands are full or otherwise to split a pick into multiple tasks, for example, where a confirmation is performed for each task (e.g., a scan of an item and/or carton for each task/sub-task).

At 610, the picking system 108 may update a graphical interface based on a verified product identity, attributes (e.g., exceptions), or other details. For instance, based on an identified exception or other attribute (e.g., expiration date, priority, wrong product, etc.), the picking system 108 may determine and display, on a picking device 158, special instructions in an interface 610a indicating how to pack, pick, or handle the identified item or order and/or perform another task. Other confirmations and instructions may also be displayed as needed for the determined task.

At 612, the picking system 108 may determine whether to capture a serial number of a product and request the same from the picker. For instance, the picking device 158 may display instructions in interface(s) (e.g., 612a) and then receive an input(s) of a serial number(s) via text or via a scan of a label(s) on the product(s). As shown in the examples, an indication of a quantity of serial numbers to be determined may be displayed in a top bar while serial numbers are populated in a list as they are received.

At 614, the picking device 158 may display one or more interfaces for identifying a quantity for the identified item. For instance, it may receive and automatically associate the quantity with the item in the database. An interface 614a may be displayed to indicate a quantity scanned (e.g., based on a quantity of scans of the item), another interface 614b may be displayed to allow user input to increase or decrease the quantity, or other interfaces may be shown.

At 616, the picking device 158 may instruct a picker to place the identified item in a defined carton (e.g., the scanned carton) and/or may receive information identifying a carton or otherwise put the pick. For instance, at 616, the picking device 158 may automatically receive a carton scan and confirm that the correct identified product is being placed into the correct carton for an order. In some instances, the graphical interfaces, before or after the scan of the carton, may receive confirmation of the number of items placed into the carton (e.g., for a cart, position on the cart, or otherwise). In some instances, for a single product type, the picking device 158 may also receive and process scans of multiple cartons into which products of the identified product type are placed.

In some implementations, the picking system 108 may determine that the identified item is applicable to a plurality of the cartons on the cart and may instruct the picker to retrieve that quantity of the item and place them into the corresponding cartons. For instance, the picking device 158 may receive scans of multiple cartons confirming picks of the plurality of items into the respective cartons, for example, as illustrated in the example interfaces of FIG. 6J.

Similarly, in some implementations, the picking system 108 may determine that multiple different items are located within a defined distance of each other and output an instruction on the picking device 158 to retrieve the multiple items at the same time. The picking system 108/device may also receive scans of the items sequentially, for example, before a carton (or multiple cartons) are scanned for the items.

The picking system 108 may confirm that the correct items are placed into the correct cartons based on the scan data matching, determine whether there are additional picks for the carton(s), cart(s), picker, etc. The picking system 108, for example, upon determining that a carton is complete, may instruct a picker via the picking device 158 to place a document or label in or on the carton.

For example, at 618, based on the items in the carton, the picking device 158 may instruct a user to place a sticker indicating that a carton contains a fragile item, liquid, hazardous materials, etc., for instance, as illustrated in the interface 618a. In some implementations, the pick device may indicate which stickers/labels to apply and/or an indication of the cartons to which to apply them. In some implementations, a diagram or layout indicating positions of cartons on a cart may be automatically generated (e.g., based on the stored locations of the cartons during setup or cart building) and displayed on the picking device 158.

At 620, upon completion of the task, issuance of the task instructions, elapsed time, or confirmation, the picking system 108 may determine that a cart is complete, for example, where all cartons have received all applicable picks. The picking system 108 may cause the picking device 158 to update the display to indicate that a cart is complete and/or receive picker confirmation that it is complete.

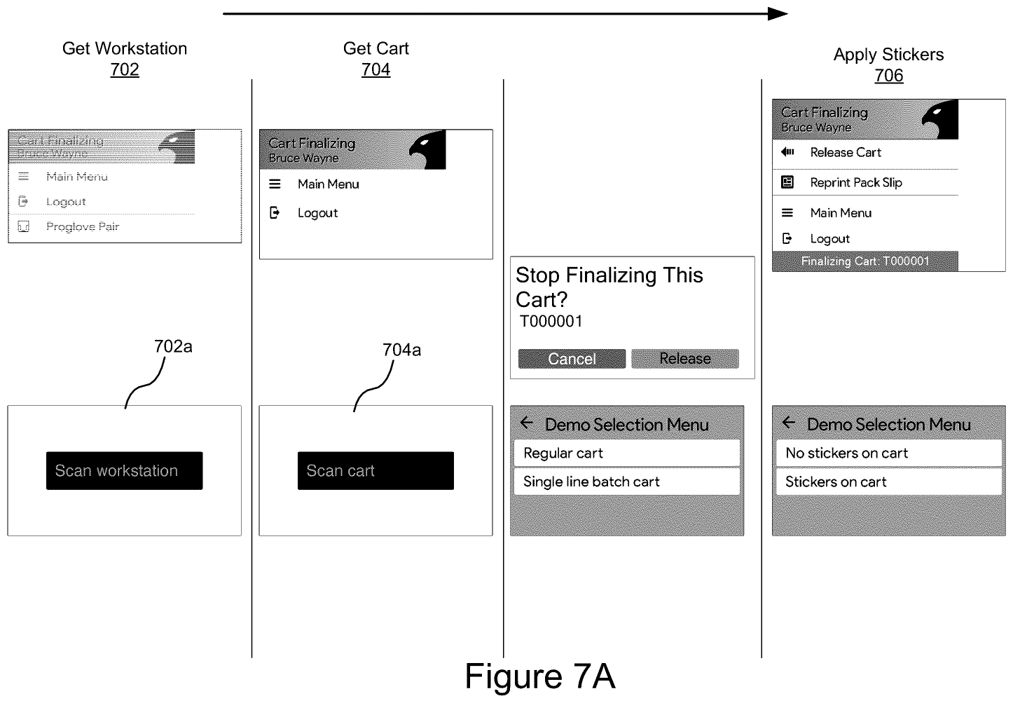

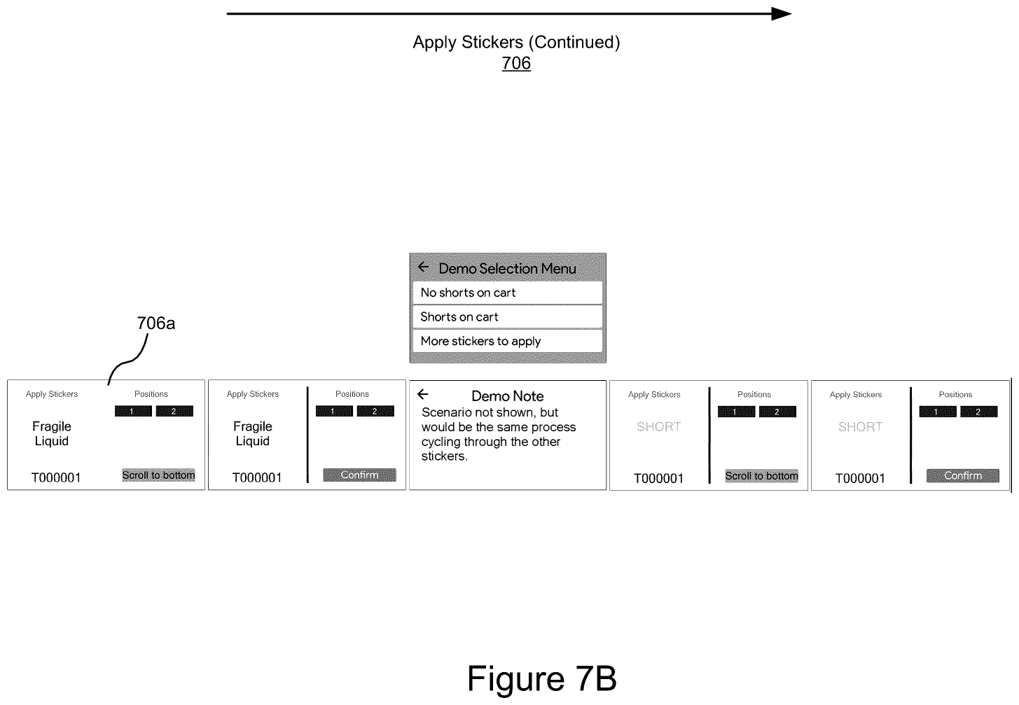

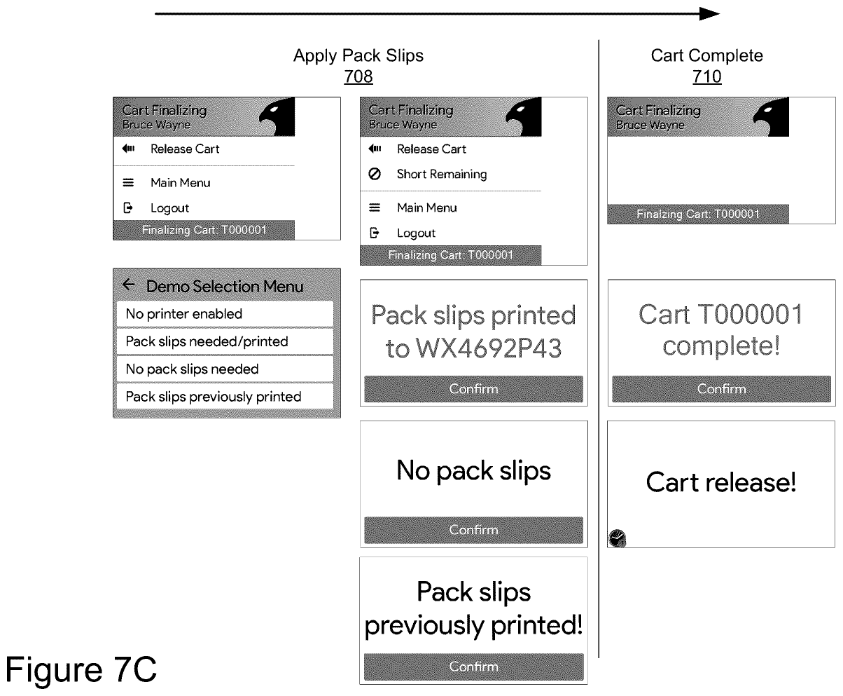

FIGS. 7A-7C illustrate an example workflow of an example method for finalizing a cart, according to some implementations. For example, once a cart has been completed/all applicable items have been picked to cartons in the cart (e.g., based on confirmation by a picker in the graphical interfaces, as noted above), the WMS 104, REX 134, dispatch system 106, or other component may instruct an AGV 114 to retrieve the cart and transport it to a finalizing station at which the cart and/or cartons may be finalized. In some instances, although not described in reference to FIGS. 7A-7C, the cart/cartons may receive additional items at a finalizing or another area, for example, the cart may initially be completed in a pick-to-cart area, navigate to a picking station, receive additional picks at the picking station, and/or navigate to a finalizing area for finalization.

The picking system 108 (e.g., via a picking device 158, as noted above) may receive a scan or input via a picking device 158 to determine a process flow, such as a flow through operations, logic, and interfaces at finalizing, as illustrated in the example, or the picking system 108 may assign a picker to a certain task, task list, or process flow. At 702, the picking system 108 may display an interface 702a and may, in response, receive scan data identifying a workstation via scan of a label at a workstation by a picking device 158, which confirms a location of a picker and that the picker is ready to perform tasks at that location.

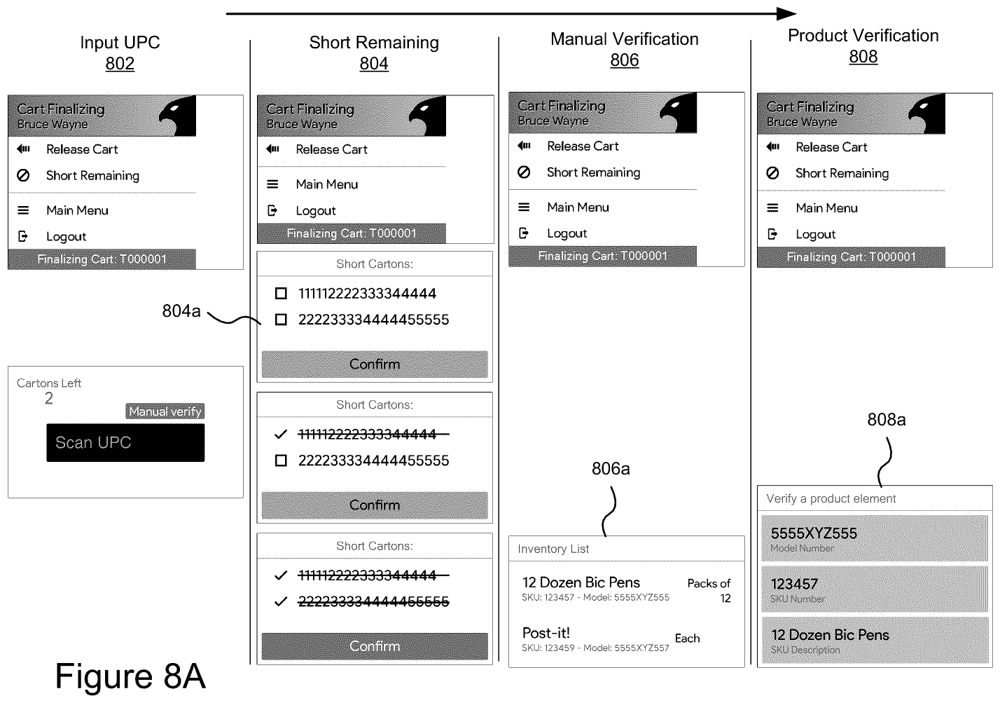

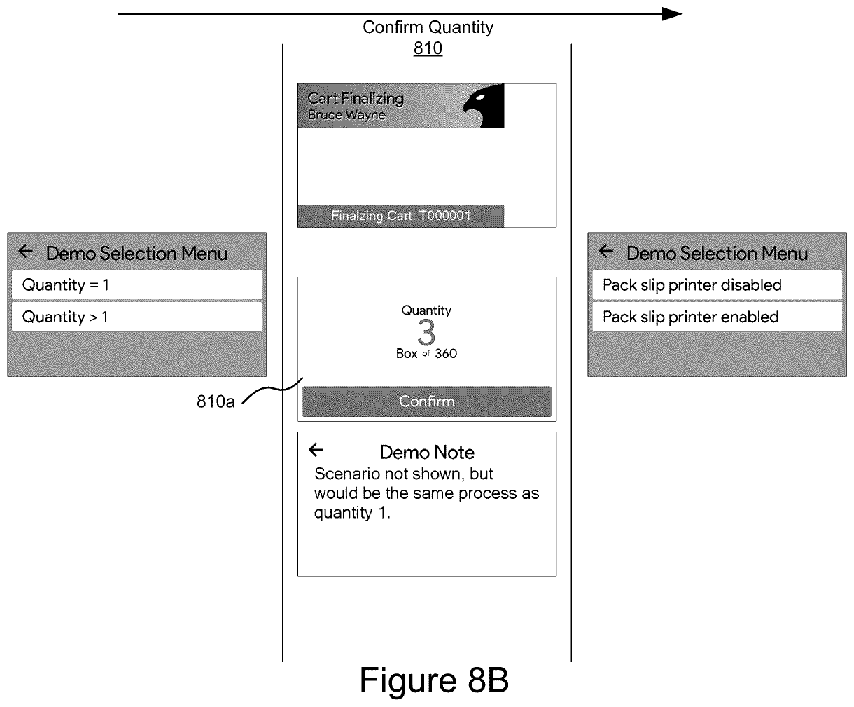

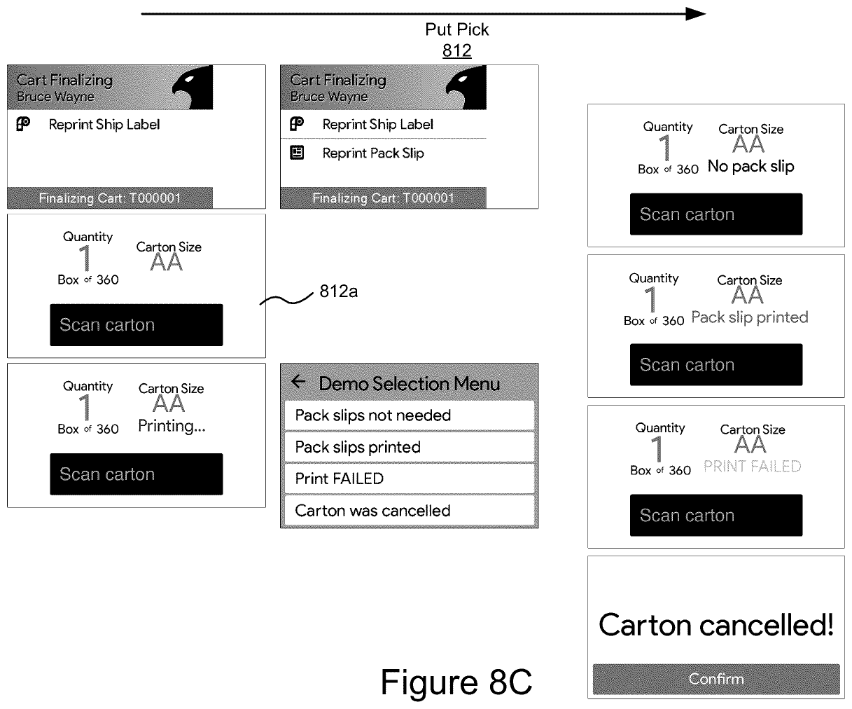

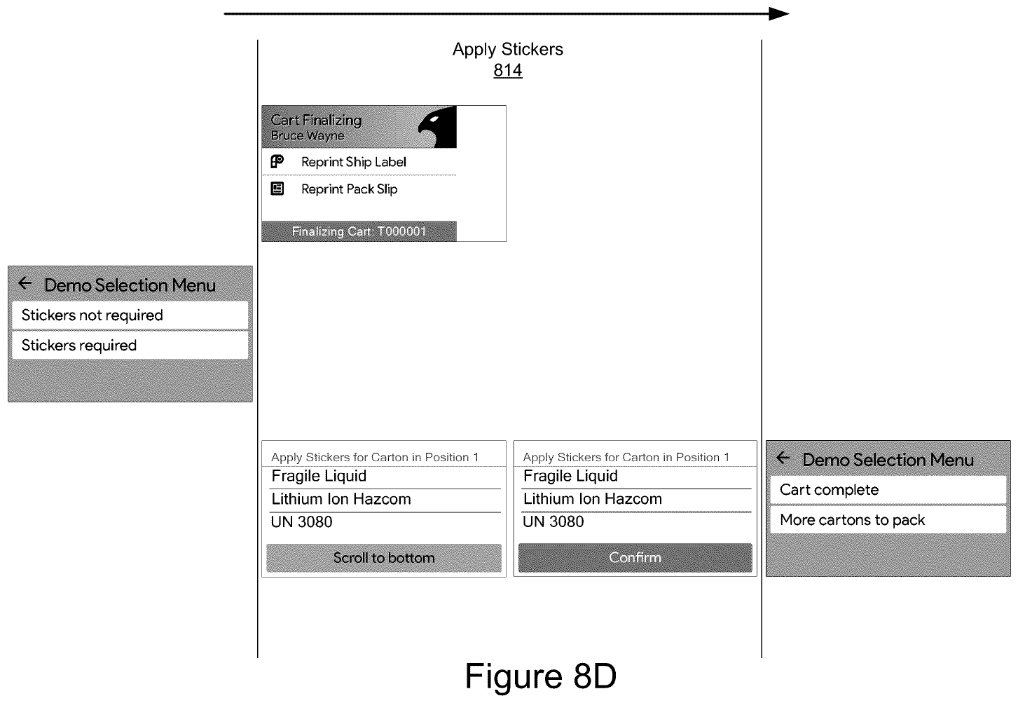

At 704, the picking system 108/device may display an interface 704a and, in response, receive a scan of a cart, determine whether it is a regular or batch cart (e.g., a batch cart may be processed as referenced below in FIGS. 8A-8D), or perform another operation.

At 706, the picking system 108 may determine whether there are stickers for a cart or carton and update/display a graphical interface (e.g., 706a) to instruct the placement of a sticker or other label. Other stickers or labels, such as for a short pick, may additionally or alternatively be displayed.

At 708, the picking system 108 may determine whether a carton requires packing slip(s), automatically print the slip(s), and instruct a picker to retrieve the slips from a defined printer and place the slips in a corresponding carton. The picking system 108 may display corresponding information in interfaces and receive confirmations or other inputs from the picker regarding the packing slip(s).

In some instances, at 710, upon receiving confirmation from the picking device 158, the picking system 108 may mark the carton and/or cart as complete and, potentially, instruct an AGV 114 to transport it to a shipping location or otherwise.

Similar to the notes above, FIGS. 8A-8D illustrate another example workflow of an example method for finalizing a cart, according to some implementations. For instance, FIGS. 8A-8D illustrate an example method of finalizing a batch cart.

At 802, the picking system 108/picking device 158 may request and, in response, receive a scan of a product (e.g., of a UPC) or another identification of a product. In some instances, manual input or verification may be performed by a user via the interfaces.

At 804, the picking system 108 may determine that there are short cartons, for example, if there is an insufficient quantity of an item for the carton(s). A picker may use an interface (e.g., 804a) to confirm which items or cartons are short. For instance, the WMS 104 or data store 120 may automatically track positions and quantities of items in a warehouse and automatically display or suggest which products may be short or reaching low inventory. In other instances, the short determination may be based on input by the picker (e.g., by scanning a short item and/or indicating the same on the graphical interface).

In some instances, at 806 and 808, the picking device 158 may receive manual verification of the item(s)/product(s), for example, by displaying text descriptions or an image of an item, which the picker may confirm on a graphical interface (e.g., 806a or 808a). The product verification may additionally or alternatively be performed based on a scan or other input.

In some instances, if the picking system 108 or picker determines that the quantity of an item is greater than one (e.g., in a task or pick line for a cart, carton, or order(s) assigned), at 810, this determination may cause the picking device 158 to display a quantity confirmation screen 810a, which may indicate a quantity of the item in a carton and, via which, the picker may confirm or set the quantity.

At 812, the picking device 158 may instruct a picker to place a pick and/or receive a confirmation of the pick, and the quantity (e.g., at 812a). The picking device 158 may allow modification, canceling, printing or placement of packing slips, or other operations. For instance, the picking system 108 may track whether a pack slip has been placed, printed, failed, or otherwise based on picker inputs or interactions with other equipment, such as printers. In some instances, based on user input, processing failures, or equipment failures, the picking system 108 may cancel a carton or request that the user restart the process.

At 814, the packing system may determine, instruct, and/or confirm application of stickers (e.g., as noted above), for example, by displaying instructions and receiving confirmations on the picking device 158.

In some instances, the example flow illustrated in FIGS. 8A-8D may be combined or operations exchanged with those described elsewhere, such as in reference to FIGS. 7A-7C, for example, to complete carts or cartons.

FIGS. 9A-9E illustrate an example workflow of an example method for receiving new items into a warehouse/fulfillment center, according to some implementations. For example, a picking device 158 may communicate with a server of a picking system 108 to perform various operations. The picking system 108 may determine to use the receiving flow for a given picking device 158, for example, based on an active assignment or a scan of a receiving area (e.g., a receiving bay) by a picking device 158. In some instances, the operations and features described in reference to these figures input data into the WMS 104 or database 120, so that the items are actively tracked and used in the system 100.

At 902, the picking device 158 may get one or more purchase orders by scanning on an interface 902a (and/or selecting on a graphical interface 902b or providing another input) a door, bay, or other area, selecting a door, for example, a user may scan a pallet, purchase order label, etc. In some cases, depending on the method of input, the picking device 158 may proceed through corresponding interfaces.

At 904, the picking device 158 may determine one or more purchase orders, for example, for the identified door or other receiving area. For example, it may automatically retrieve details for purchase orders corresponding to a scanned door. Depending on the implementation, certain details of the purchase orders (e.g., sets of items received, expected to be received, etc., in one or more shipments) are displayed on one or more graphical interfaces. Depending on the implementations, different shades or colors may indicate data, for example, a red background may indicate that no shipments have been received (or processed/scanned), a yellow background may indicate that it has been partially received, or a green background may indicate that it is completely received. The picking device 158 may receive a scan of a UPC or other product label in a shipment or pallet, determine attributes of it (e.g., expiration date, priority, whether it is needed immediately for a pick, etc.), or perform other operations.

In some implementations, the picking system 108/picking device 158 may determine a purchase order by receiving a scan of any item in a shipment (e.g., a pallet, product, case, etc.), which may allow the picking system 108 to filter the list of available or displayed purchase orders to those that include or are associated with the scanned item. Accordingly, the list can be significantly shortened and improve navigation on a device with a limited screen size.

At 906, the picking device 158 may display an interface 906a and receive input for the scanned item to determine its expiration date(s), or otherwise. The WMS 104 or another system may automatically process the expiration date(s) (e.g., in light of processing time, how frequently the items are ordered, etc.) to determine handling information, such as priority or storage requirements. For instance, the WMS 104 or picking system 108 may process or store (e.g., by directing the picker and/or a robot) products with sooner expiration dates differently. Similarly, if a product is needed for an immediate pick, the picking device 158 may direct the picker to process it differently.

At 908, the picking device 158 may display one or more graphical user interfaces requesting a quantity for the item, receiving an input, and/or receiving a confirmation for the quantity, for instance.

At 910, the picking system 108/device may receive a scan of a pallet, for example for a pallet of the same or different items. For instance, the picking device 158 may display an interface selected by a user or surfaced based on a previous interaction or scan, such as at 908, which may cause the picking device 158 to receive a scan of a pallet label.

At 912, the picking system 108 via the picking device 158 may display an interface and/or receive a scan of a case label, which may identify, to the picking system 108 and/or WMS 104, quantity and/or types of items in a case. In some instances, the scan may be of a case of items or of one or more of the items themselves. As multiple labels are scanned, identifiers may be added, and a count may be incremented upward on the interface(s) of the picking device 158. In some implementations, the picking device 158 may display a location that is active for the tasks in a top bar of the interface(s).

At 914, the picking system 108 may determine attributes for the identified items, cases, pallets, etc., such as variances from the quantity expected in the purchase order. For instance, if the purchase order expected 5 items, but only 4 items were received (e.g., as indicated in scans and/or quantity confirmations), the picking system 108 may mark the item has having a variance from the picking order and may corresponding track the status of the picking order by assigning different color statuses, as described above.

At 916, if all scans for a door, pallet, case, purchase order, or otherwise are complete, the system may mark its status as complete and update the graphical interface(s) accordingly. For instance, it may mark the purchase order as complete and release it for processing in other areas of the building (e.g., picking, as noted above).

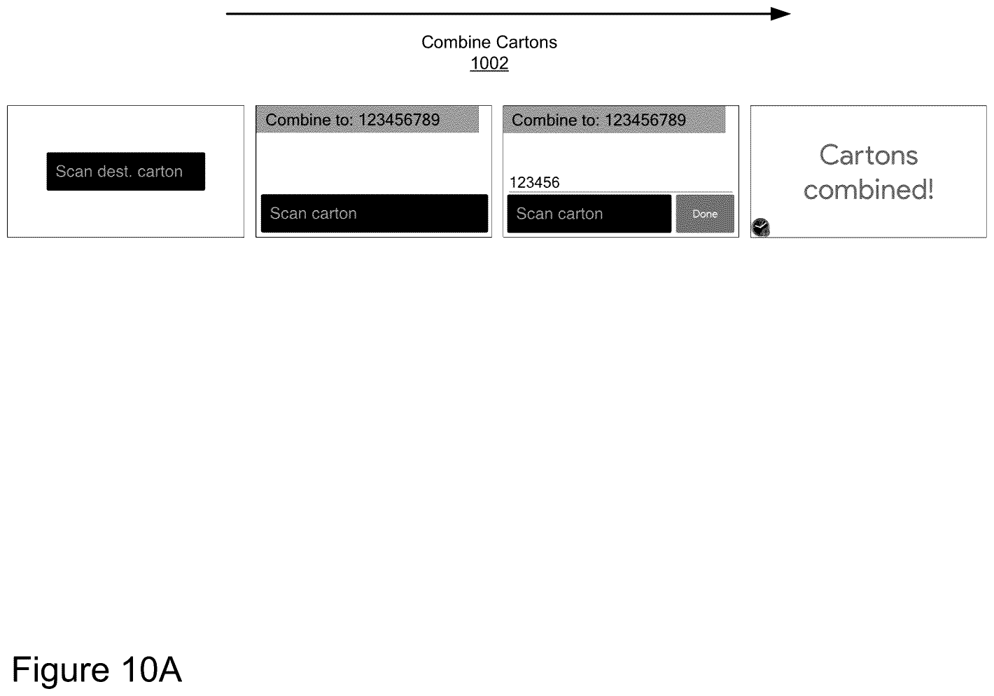

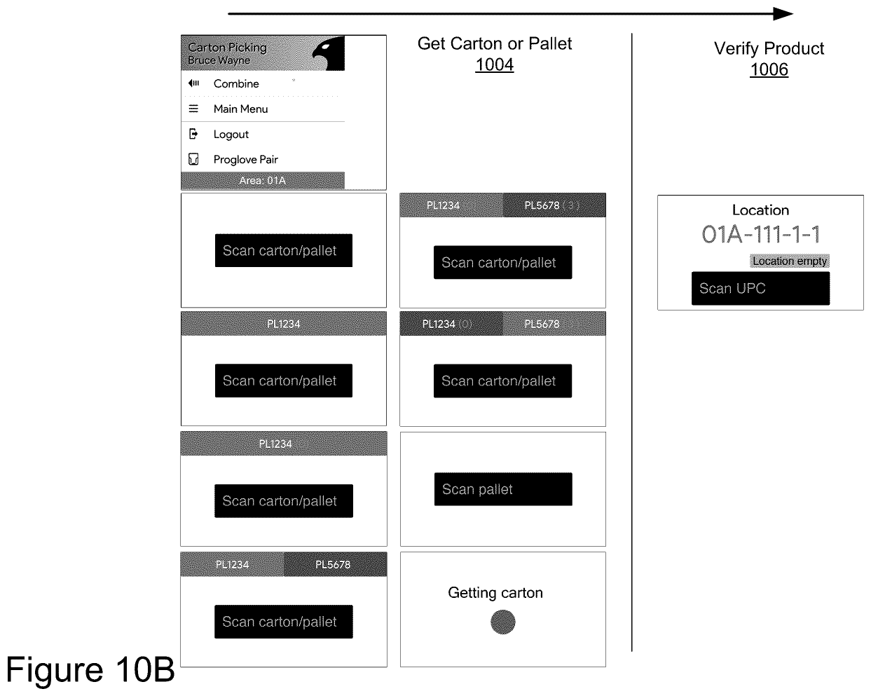

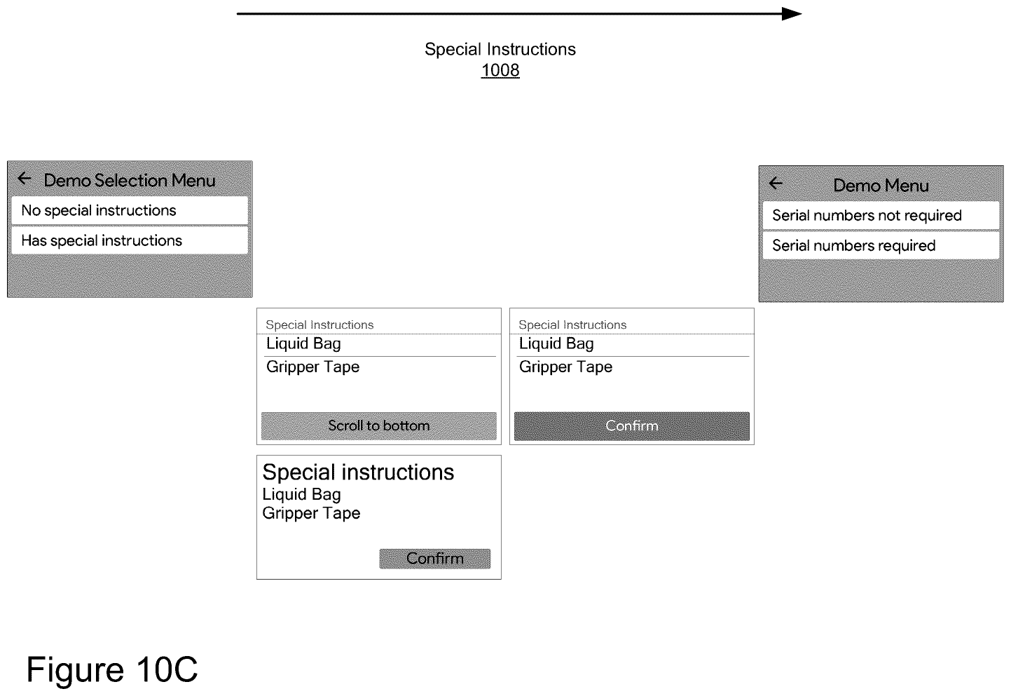

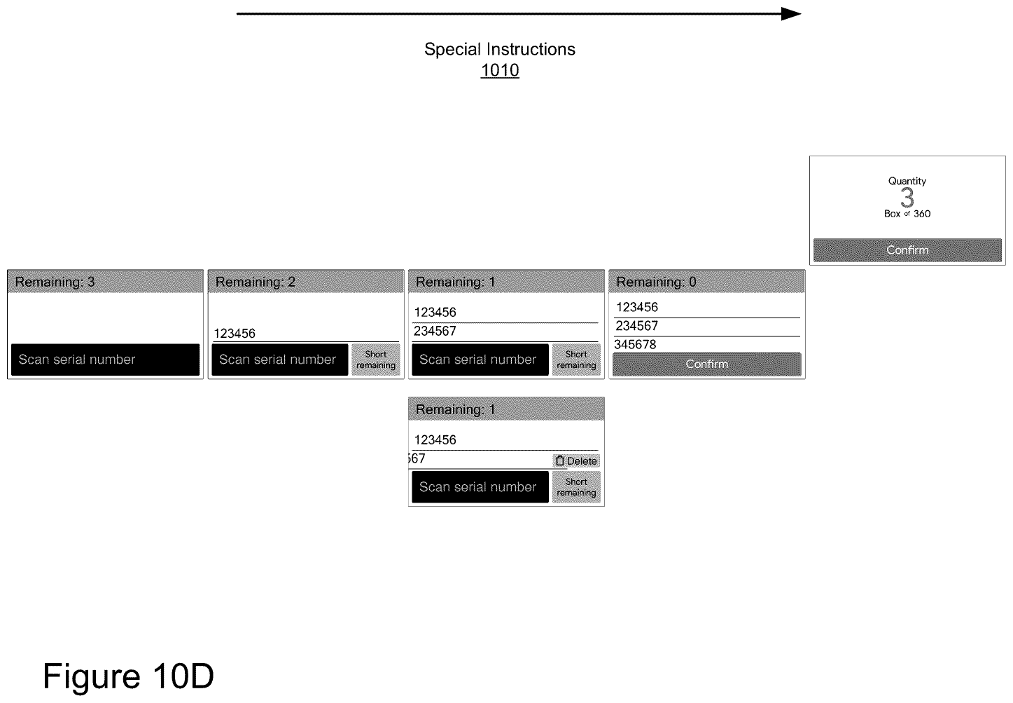

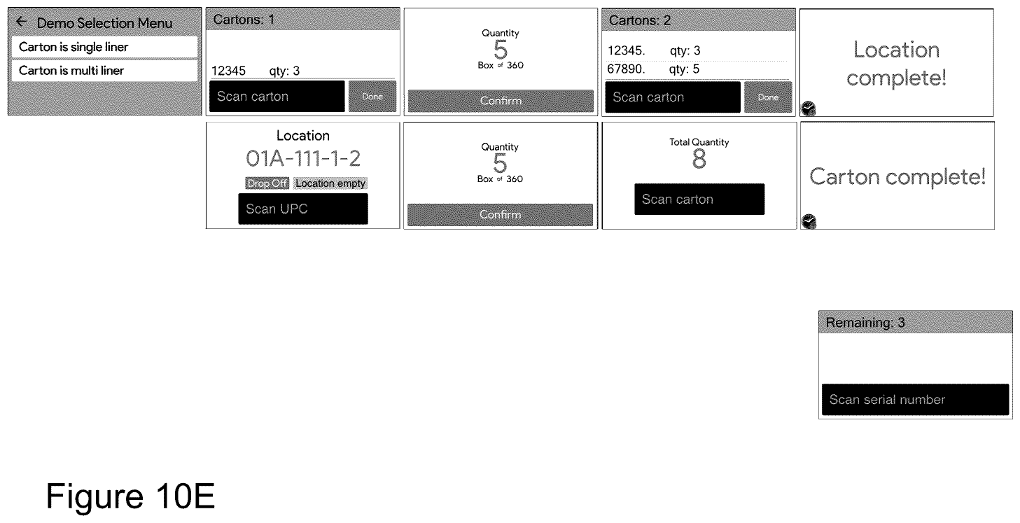

FIGS. 10A-10E illustrate an example workflow for an example for a unit-pick non con (e.g., for non-conveyable or large packages, though other implementations are possible) process, according to some implementations, which may include combining multiple picks or multiple cartons, as noted below.

At 1002, the picking system 108 may combine cartons, for example, by receiving scan data of one or multiple cartons from a picking device 158 and confirming or indicating to combine the cartons on the graphical interface(s).

At 1004, the picking system 108 may get a carton or pallet, for example, by receiving scan data of a carton or pallet from a picking device 158, for example, as noted in more detail above. At 1006, the picking system 108 may verify a product by receiving a scan of UPC or another label on the product.

At 1008, the picking system 108 may determine whether the identified product has special instructions, requires a defined serial number, or otherwise, as discussed above. At 1010, the picking device 158 may receive one or more scans or inputs of serial numbers, confirm the same, and confirm or set a quantity, as described in further detail above. In some instances, the graphical interfaces allow the picker to delete a serial number or make another modification.

At 1012, the picking system 108 may determine cartons, for example, by displaying interfaces at which the picking device 158 receives one or a plurality of scans and/or quantity confirmations for the cartons. In some implementations, as the scans occur, the interfaces may build a simple list and count. In some instances, it may indicate that the carton(s) is/are complete, request scans of serial numbers, or perform other operations.

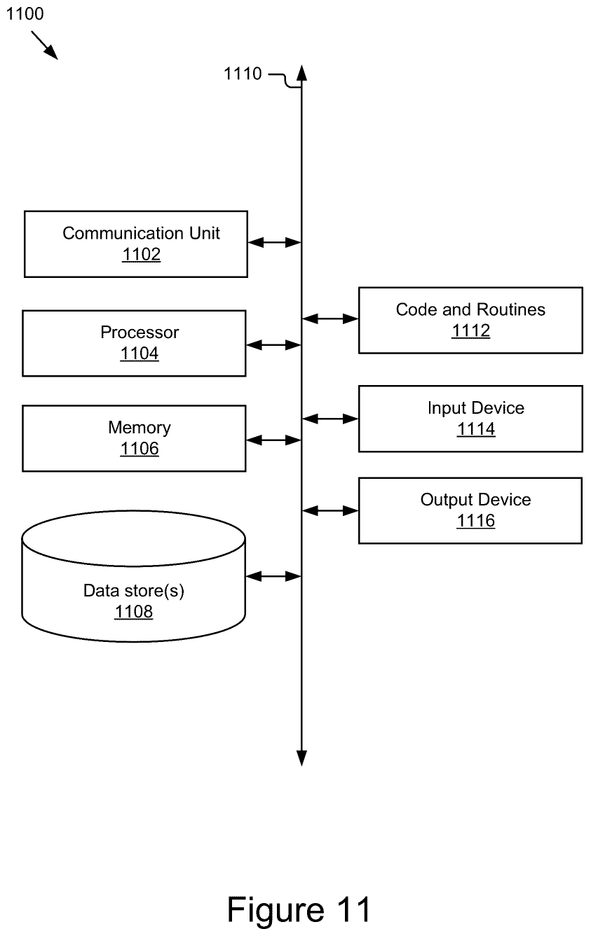

FIG. 11 is a block diagram illustrating an example computing system 1100. The example computing system 1100 may correspond to a WES 102, a WMS 104, a dispatch system 106, a picking system 108, a picking device 158, a REX 134, or a component thereof, for example.

The code and routines 1112 may include computer logic executable by the processor 1104 on a computing system 1100 to provide for the functionality described in reference to one or more of the components of the system 100. For instance, in some implementations, the release logic engine 142 may include code and routines.

As depicted, the computing system 1100 may include a processor 1104, a memory 1106, a communication unit 1102, an output device 1116, an input device 1114, and database(s) 1108, which may be communicatively coupled by a communication bus 1110. The computing system 1100 depicted in FIG. 11 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 1100 may include various operating systems, sensors, additional processors, and other physical configurations. Although, for purposes of clarity, FIG. 11 only shows a single processor 1104, memory 1106, communication unit 1102, etc., it should be understood that the computing system 1100 may include a plurality of one or more of these components.

The processor 1104 may execute software instructions by performing various input, logical, and/or mathematical operations. The processor 1104 may have various computing architectures to method data signals including, for example, a complex instruction set computer (CISC) architecture, a reduced instruction set computer (RISC) architecture, and/or an architecture implementing a combination of instruction sets. The processor 1104 may be physical and/or virtual and may include a single core or plurality of processing units and/or cores. In some implementations, the processor 1104 may be capable of generating and providing electronic display signals to a display device, supporting the display of images, capturing and transmitting images, performing complex tasks including various types of feature extraction and sampling, etc. In some implementations, the processor 1104 may be coupled to the memory 1106 via the bus 1110 to access data and instructions therefrom and store data therein. The bus 1110 may couple the processor 1104 to the other components of the computing system 1100 including, for example, the memory 1106, the communication unit 1102, the input device 1114, the output device 1116, and the database(s) 1108.

The memory 1106 may store and provide access to data to the other components of the computing system 1100. The memory 1106 may be included in a single computing device or a plurality of computing devices. In some implementations, the memory 1106 may store instructions and/or data that may be executed by the processor 1104. For example, the memory 1106 may store the code and routines 1112. The memory 1106 is also capable of storing other instructions and data, including, for example, an operating system, hardware drivers, other software applications, databases, etc. The memory 1106 may be coupled to the bus 1110 for communication with the processor 1104 and the other components of computing system 1100.

The memory 1106 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 1104. In some implementations, the memory 1106 may include one or more of volatile memory and non-volatile memory (e.g., RAM, ROM, hard disk, optical disk, etc.). It should be understood that the memory 1106 may be a single device or may include multiple types of devices and configurations.

The bus 1110 can include a communication bus for transferring data between components of a computing device or between computing devices, a network bus system including a network or portions thereof, a processor mesh, a combination thereof, etc. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 1102 may include one or more interface devices (I/F) for wired and wireless connectivity among the components of the system 100. For instance, the communication unit 1102 may include various types known connectivity and interface options. The communication unit 1102 may be coupled to the other components of the computing system 1100 via the bus 1110. The communication unit 1102 may be electronically communicatively coupled to a network (e.g., wiredly, wirelessly, etc.). In some implementations, the communication unit 1102 can link the processor 1104 to a network, which may in turn be coupled to other processing systems. The communication unit 1102 can provide other connections to a network and to other entities of the system using various standard communication protocols.

The input device 1114 may include any device for inputting information into the computing system 1100. In some implementations, the input device 1114 may include one or more peripheral devices. For example, the input device 1114 may include a keyboard, a pointing device, microphone, an image/video capture device (e.g., camera), a touch-screen display integrated with the output device 1116, etc.

The output device 1116 may be any device capable of outputting information from the computing system 1100. The output device 1116 may include one or more of a display (LCD, OLED, etc.), a printer, a 3D printer, a haptic device, audio reproduction device, touch-screen display, etc. In some implementations, the output device is a display which may display electronic images and data output by the computing system 1100 for presentation to a user, such as a picker or associate in the order fulfillment center. In some implementations, the computing system 1100 may include a graphics adapter (not shown) for rendering and outputting the images and data for presentation on output device 1116. The graphics adapter (not shown) may be a separate processing device including a separate processor and memory (not shown) or may be integrated with the processor 1104 and memory 1106.

The database(s) are information source(s) for storing and providing access to data. The data stored by the database(s) 1108 may be organized and queried using various criteria including any type of data stored by them, such as the data in the data store 120 and other data discussed herein. The database(s) 1108 may include file systems, data tables, documents, databases, or other organized collections of data. Examples of the types of data stored by the database(s) 1108 may include the data described herein, for example, in reference to the data store 120.

The database(s) 1108 may be included in the computing system 1100 or in another computing system and/or storage system distinct from but coupled to or accessible by the computing system 1100. The database(s) 1108 can include one or more non-transitory computer-readable mediums for storing the data. In some implementations, the database(s) 1108 may be incorporated with the memory 1106 or may be distinct therefrom. In some implementations, the database(s) 1108 may store data associated with a database management system (DBMS) operable on the computing system 1100. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

It should be noted that the components described herein may be further delineated or changed without departing from the techniques described herein. For example, the processes described throughout this disclosure may be performed by fewer, additional, or different components.

It should be understood that the methods described herein are provided by way of example, and that variations and combinations of these methods, as well as other methods, are contemplated. For example, in some implementations, at least a portion of one or more of the methods represent various segments of one or more larger methods and may be concatenated or various steps of these methods may be combined to produce other methods which are encompassed by the present disclosure. Additionally, it should be understood that various operations in the methods are iterative, and thus repeated as many times as necessary generate the results described herein. Further the ordering of the operations in the methods is provided by way of example and it should be understood that various operations may occur earlier and/or later in the method without departing from the scope thereof.

In the above description, for purposes of explanation, numerous specific details are set forth in order to provide a thorough understanding of the present disclosure. However, it should be understood that the technology described herein can be practiced without these specific details in various cases. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening I/O controllers. The data processing system may include an apparatus may be specially constructed for the required purposes, or it may comprise a general-purpose computer selectively activated or reconfigured by a computer program stored in the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects may not be mandatory or significant, and the mechanisms that implement the specification or its features may have different names, divisions, and/or formats.

Furthermore, the modules, routines, features, attributes, methodologies, and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
providing, by one or more processors via one or more graphical user interfaces, a first instruction to a user to perform a first scan of one or more first items at a first location;
receiving, by the one or more processors, the first scan of the one or more first items;
identifying, by the one or more processors, the one or more first items based on the first scan;
updating, by the one or more processors, the one or more graphical user interfaces, based on the identified one or more first items; and
updating, by the one or more processors, a computer file associated with the first instruction to indicate a scan of the one or more first items.

2. The computer-implemented method of claim 1, further comprising:
receiving, by the one or more processors, scan data of a second scan of a first label at a work location, the second scan preceding the first scan; and
based on the second scan, determining a process flow including a set of multiple graphical user interfaces indicating a set of multiple tasks for the work location, the set of multiple graphical user interfaces including the one or more graphical user interfaces.

3. The computer-implemented method of claim 1, further comprising:
receiving, by the one or more processors, a second scan of a first carton;
identifying, by the one or more processors, the first carton based on the second scan; and
associating, by the one or more processors, the one or more first items with the first carton based on the second scan of the first carton in the computer file.

4. The computer-implemented method of claim 1, further comprising:
displaying, by the one or more processors, a graphical user interface requesting verification of a quantity of the one or more first items based on receiving the first scan; and
based on receiving the verification of the quantity, displaying a subsequent task in a task list on the one or more graphical user interfaces, the task list including a pick of the one or more first items and the subsequent task including a pick of one or more second items.

5. The computer-implemented method of claim 1, further comprising:
providing, by the one or more processors via the one or more graphical user interfaces, a second instruction to the user to apply one or more labels to a first carton based on the first scan and the identified one or more first items.

6. The computer-implemented method of claim 1, further comprising:
determining, by the one or more processors, one or more purchase orders, the one or more purchase orders identifying a set of items expected to be received in one or more shipments;
receiving, by the one or more processors, second scan data for a second scan of one or more of a pallet label and a case label in the one or more shipments; and
determining, by the one or more processors, the first instruction indicating the one or more first items based on the second scan.

7. The computer-implemented method of claim 1, further comprising:
determining, by the one or more processors, expiration information for the one or more first items using a client picking device; and
displaying, by the one or more processors on the one or more graphical user interfaces, handling information based on the determined expiration information.

8. The computer-implemented method of claim 1, wherein:
the one or more graphical user interfaces providing the first instruction are displayed on portable client picking device, the portable client picking device being wirelessly communicatively coupled with a scanning device to receive scan data from the first scan.

9. The computer-implemented method of claim 1, wherein:
the first instruction is displayed on a graphical user interface including a single active instruction, the one or more processors determining an operation based on the first instruction being displayed and the first scan being received.

10. The computer-implemented method of claim 1, wherein:
the user navigates through a workflow of graphical user interfaces by scanning external labels on one or more of a pallet, a physical location, a carton, and a product.

11. A system comprising:
one or more processors; and
a computer-memory storing instructions that, when executed by the one or more processors, cause the one or more processors to perform operations comprising:
providing, via one or more graphical user interfaces, a first instruction to a user to perform a first scan of one or more first items at a first location;
receiving the first scan of the one or more first items;
identifying the one or more first items based on the first scan;
updating the one or more graphical user interfaces, based on the identified one or more first items; and
updating a computer file associated with the first instruction to indicate a scan of the one or more first items.

12. The system of claim 11, wherein the operations further comprise:
receiving scan data of a second scan of a first label at a work location, the second scan preceding the first scan; and
based on the second scan, determining a process flow including a set of multiple graphical user interfaces indicating a set of multiple tasks for the work location, the set of multiple graphical user interfaces including the one or more graphical user interfaces.

13. The system of claim 11, wherein the operations further comprise:
receiving a second scan of a first carton;
identifying the first carton based on the second scan; and
associating the one or more first items with the first carton based on the second scan of the first carton in the computer file.

14. The system of claim 11, wherein the operations further comprise:
displaying a graphical user interface requesting verification of a quantity of the one or more first items based on receiving the first scan; and
based on receiving the verification of the quantity, displaying a subsequent task in a task list on the one or more graphical user interfaces, the task list including a pick of the one or more first items and the subsequent task including a pick of one or more second items.

15. The system of claim 11, wherein the operations further comprise:
providing, via the one or more graphical user interfaces, a second instruction to the user to apply one or more labels to a first carton based on the first scan and the identified one or more first items.

16. The system of claim 11, wherein the operations further comprise:
determining one or more purchase orders, the one or more purchase orders identifying a set of items expected to be received in one or more shipments;
receiving second scan data for a second scan of one or more of a pallet label and a case label in the one or more shipments; and
determining the first instruction indicating the one or more first items based on the second scan.

17. The system of claim 11, wherein the operations further comprise:
determining expiration information for the one or more first items using a client picking device; and
displaying, on the one or more graphical user interfaces, handling information based on the determined expiration information.

18. The system of claim 11, wherein the operations further comprise:
the one or more graphical user interfaces providing the first instruction are displayed on portable client picking device, the portable client picking device being wirelessly communicatively coupled with a scanning device to receive scan data from the first scan.

19. The system of claim 11, wherein the operations further comprise:
the first instruction is displayed on a graphical user interface including a single active instruction, the one or more processors determining an operation based on the first instruction being displayed and the first scan being received.

20. The system of claim 11, wherein the operations further comprise:
the user navigates through a workflow of graphical user interfaces by scanning external labels on one or more of a pallet, a physical location, a carton, and a product.
